(19) United States
(12) Patent Application Publication
(10) Pub. No.: US 2021/0259004 A1
(43) Pub. Date: Aug. 19, 2021

(54) USER TERMINAL

(71) Applicant: NTT DOCOMO, INC., Tokyo (JP)

(72) Inventors: Kazuki Takeda, Tokyo (JP); Satoshi Nagata, Tokyo (JP); Lihui Wang, Beijing (CN); Xiaolin Hou, Beijing (CN)

(73) Assignee: NTT DOCOMO, INC., Tokyo (JP)

(21) Appl. No.: 17/253,431

(22) PCT Filed: Jun. 18, 2018
(86) PCT No.: PCT/JP2018/023164

§ 371 Date: Dec. 17, 2020

(51) Int. Cl. H04W 72/12; H04W 72/04; H04L 1/16

(52) U.S. Cl. CPC H04W 72/1289; H04L 1/1607; H04W 72/0413

(57) ABSTRACT

A user terminal according to an aspect of the present disclosure includes: a receiving section that receives a downlink shared channel repetitively transmitted from a plurality of transmission and reception points; and a control section that controls transmission of delivery acknowledgment information at each repetition of the downlink shared channel or transmission of delivery acknowledgment information generated based on all the repetitions of the downlink shared channel, using an uplink control channel to at least one of the plurality of transmission and reception points.

### TECHNICAL FIELD

The present disclosure relates to a user terminal in a next-generation mobile communication system.

### BACKGROUND ART

In the universal mobile telecommunications system (UMTS) network, the specifications of long-term evolution (LTE) have been drafted for the purpose of further increasing high speed data rates, providing lower delays, and the like (see Non Patent Literature 1). In addition, the specifications of LTE-A (LTE Advanced, LTE Rel. 10, 11, 12, 13) have been drafted for the purpose of further increasing the capacity and sophistication of LTE (LTE Rel. 8, 9).

Successor systems of LTE are also under study (also referred to as, for example, “FRA (Future Radio Access),” “5G (5th generation mobile communication system),” “5G+ (plus),” “NR (New Radio),” “NX (New radio access),” “FX (Future generation radio access),” “LTE Rel. 14,” “LTE Rel. 15 or later versions” and so on).

In the existing LTE system (for example, LTE Rel.8-14), a user terminal (UE) controls reception of a downlink shared channel (for example, Physical Downlink Control Channel (PDCCH)) based on downlink control information (for example, Downlink Control Information (DCI), also referred to as DL assignment) that is transferred via a downlink control channel (for example, Physical Downlink Shared Channel (PDSCH). Also, the user terminal controls transmission of the uplink shared channel (for example, physical uplink shared channel (PUSCH)) based on the DCI (also referred to as UL grant).

### CITATION LIST

### Non Patent Literature

Non Patent Literature 1:3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

For future wireless communication systems (for example, NR, 5G, 5G+ or Rel. 15 or later), it is considered to perform communication using beam forming (BF). Therefore, it is considered that a user terminal, based on the information about Quasi-Co-Location (QCL) (QCL information) of at least one of a given channel and signal (channel/signal), controls the reception processing of the channel/signal (for example, at least one of demapping, demodulation, and decoding).

The QCL information of a given channel/signal (for example, PDSCH, PDCCH) is also called transmission configuration indication or transmission configuration indicator state (TCI-state) of the given channel/signal.

For the above-mentioned future wireless communication system, it is considered to transmit the downlink shared channel (for example, PDSCH) by repetition. It is also considered to transmit the downlink shared channel from a plurality of different transmission and reception points (TRPs) every given number of repetitions (for example, one repetition).

However, when the downlink shared channel is transmitted from a different TRP for each given number of repetitions, there is a problem with how to feed back delivery acknowledgment information for the downlink shared channel (also called Hybrid Automatic Repeat reQuest-Acknowledge (HARQ-ACK), Acknowledge or Non-Acknowledge (ACK or NACK), A/N, or the like).

Therefore, an object of the present disclosure is to provide a user terminal that is capable of appropriately controlling feedback of delivery acknowledgment information of a downlink shared channel when repetitive transmission of the downlink shared channel is performed from different TRPs.

### Solution to Problem

A user terminal according to an aspect of the present disclosure includes: a receiving section that receives a downlink shared channel repetitively transmitted from a plurality of transmission and reception points; and a control section that controls transmission of delivery acknowledgment information at each repetition of the downlink shared channel or transmission of delivery acknowledgment information generated based on all the repetitions of the downlink shared channel, using an uplink control channel to at least one of the plurality of transmission and reception points.

### Advantageous Effects of Invention

According to one aspect of the present disclosure, it is possible to appropriately control feedback of delivery acknowledgment information of the downlink shared channel when repetitive transmission of the downlink shared channel is performed from different TRPs.

### BRIEF DESCRIPTION OF DRAWINGS

FIGS. 1A and 1B are diagrams to show examples of repetitive transmission of channel/signal using a plurality of TRPs.

FIG. 2 is a diagram to show an example of first HARQ-ACK feedback according to a first aspect.

FIG. 3 is a diagram to show an example of setting of spatial relation information using higher layer signaling in the first HARQ-ACK feedback according to the first aspect.

FIG. 4 is a diagram to show an example of setting of spatial relation information using DCI in the first HARQ-ACK feedback according to the first aspect.

FIG. 5 is a diagram to show an example of second HARQ-ACK feedback according to the first aspect.

FIGS. 6A and 6B are diagrams to show an example of setting of spatial relation information using higher layer signaling in the second HARQ-ACK feedback according to the first aspect.

FIGS. 7A and 7B are diagrams to show an example of setting of spatial relation information using DCI in the second HARQ-ACK feedback according to the first aspect.

FIG. 8 is a diagram to show an example of HARQ-ACK feedback according to the second aspect.

FIGS. 9A and 9B are diagrams to show examples of HARQ-ACK feedback according to a third aspect.

FIG. 10 is a diagram to show an example of HARQ-ACK feedback according to a fourth aspect.

FIG. 11 is a diagram to show an example of HARQ-ACK feedback according to a fifth aspect.

FIG. 12 is a diagram to show an example of a schematic structure of a radio communication system according to one embodiment.

FIG. 13 is a diagram showing an example of an overall configuration of a radio base station according to one embodiment.

FIG. 14 is a diagram showing an example of a functional configuration of the radio base station according to the embodiment.

FIG. 15 is a diagram showing an example of an overall configuration of a user terminal according to one embodiment.

FIG. 16 is a diagram showing an example of a functional configuration of the user terminal according to the embodiment.

FIG. 17 is a diagram to show an example of a hardware structure of a radio base station and a user terminal according to one embodiment.

### DESCRIPTION OF EMBODIMENTS

In future wireless communication systems (for example, NR, 5G, 5G+, or Rel. 15 or later), it is considered to transmit at least one of a channel and a signal (channel/signal) by repetition. More specifically, it is considered to perform repetitive transmission of a channel/signal using a plurality of transmission and reception points (TRPS).

The channel/signal is, for example, PDSCH, PDCCH, PUSCH, PUCCH, DL-RS, uplink reference signal (UL-RS), or the like, but is not limited to them.

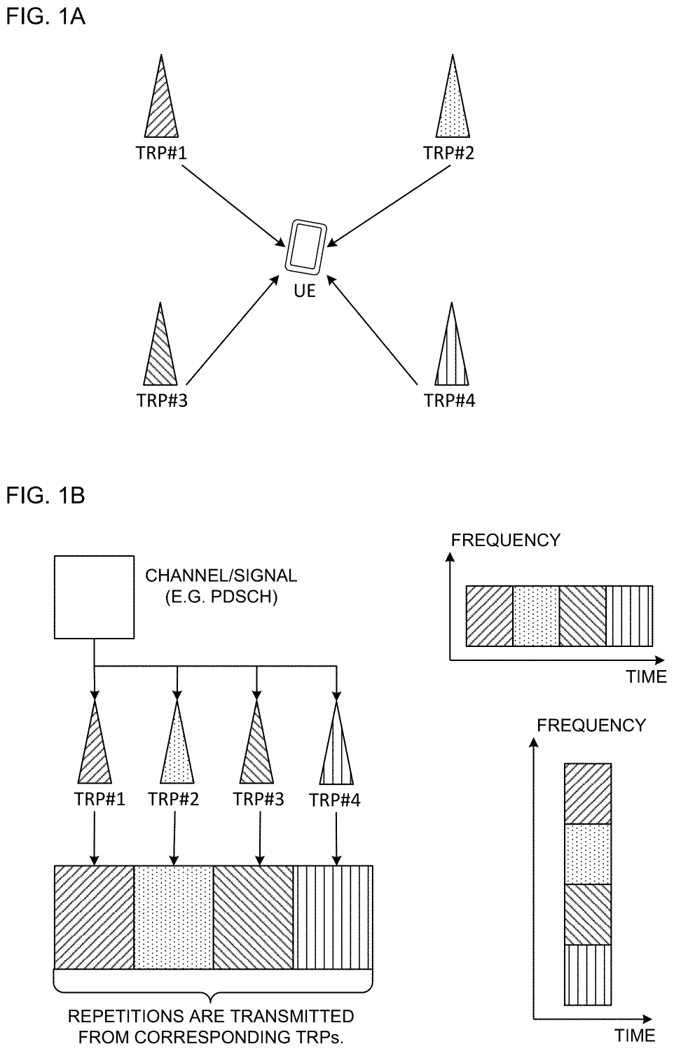

FIGS. 1A and 1B are diagrams to show examples of repetitive transmission of channel/signal using a plurality of TRPs. For example, FIGS. 1A and 1B show examples of PDSCH repetitive transmission using TRPs #1 to #4. Note that FIG. 1A shows an example in which the TRPs #1 to #4 are different in geographical position (TCI-state), but the present invention is not limited to this. The TRPs #1 to #4 may be different antenna panels installed at the same transmission location. Further, the number of TRPs used for the repetitive transmission is not limited to that shown in the figure.

As shown in FIG. 1B, the identical PDSCH (or DL data) may be copied to a plurality of TRPs, and PDSCH may be repetitively transmitted. Here, the “copying of DL data” may mean copying at least one of an information bit sequence, a code block, a transport block, and a code word sequence after encoding, which form the DL data.

Alternatively, the “copying of DL data” does not necessarily represent the duplication of all the same bit strings, but may represent the duplication of at least a part of the code word generated from the same information bit string or at least a part of the modulation symbol sequence. For example, the RV of the code words obtained by encoding a certain information bit sequence may be identical or different among the plurality of copied DL data. Alternatively, the plurality of copied DL data may be a modulation symbol sequence obtained by modulating the different RV or the same RV. All the plurality of copied DL data is transmitted as PDSCH. The PDSCH may be repetitive with resources different in at least one of time domain and frequency domain.

For example, as shown in FIG. 1B, PDSCH may be repetitive with resources (for example, one or more slots) that are identical in frequency domain continuous and continuous in the time domain. Alternatively, PDSCH may be repetitive with resources that are identical in time domain and continuous in the frequency domain (for example, RB groups (RBGs) including one or more resource blocks (RBs) or one or more RBs). Each repetition may be sent to a different TRP.

Note that FIG. 1B shows the case where the plurality of resources corresponding to different repetitions is continuous in the time domain or the frequency domain, but they may not be continuous. The plurality of resources may be resources that are different in both the time domain and the frequency domain.

FIG. 1B shows the case where PDSCH is transmitted to a different TRP at each repetition. However, the present invention is not limited to this, and PDSCH may be transmitted to a different TRP at each given number of repetitions (one or more repetitions).

Note that “TRP” may be paraphrased as network, radio base station, antenna device, antenna panel, serving cell, cell, component carrier (CC), carrier, or the like. With respect to different transmission/reception signals or channels, “TRP is identical” means that the TCI-state, QCL or QCL is identical among the different transmission/reception signals or channels or among their reference signals. With respect to different transmission/reception signals or channels, “TRP is different” means that the TCI-state, QCL or QCL relationship is different among the different transmission/reception signals or channels or among their reference signals.

(QCL)

For the future wireless communication system, it is considered that a user terminal, based on the information about Quasi-Co-Location (QCL) (QCL information) of at least one of a given channel and signal (channel/signal), controls the reception processing of the channel/signal (for example, at least one of demapping, demodulation, and decoding).

The QCL here is an index indicating the statistical property of the channel/signal. For example, when one signal and another signal have a QCL relationship, this may mean that these different signals can be assumed to be identical in at least one of doppler shift, doppler spread, average delay, delay spread and spatial parameter (for example, spatial Rx parameter) (or to be QCL in at least one of these parameters).

The spatial reception parameter may correspond to a reception beam (for example, a reception analog beam) of the user terminal, and the beam may be specified based on the spatial QCL. The QCL and at least one element of QCL in the present disclosure may be interpreted as spatial QCL (sQCL).

A plurality of types of QCL (QCL type) may be defined. For example, four QCL types A to D with different parameters (or parameter set) that can be assumed to be identical may be provided. These parameters are as follows:
QCL type A: Doppler shift, Doppler spread, average delay and delay spread;
QCL Type B: Doppler shift and Doppler spread;
QCL type C: Doppler shift and average delay; and
QCL type D: Spatial reception parameter.

The state of transmission configuration indication or transmission configuration indicator (TCI) (TCI-state) may indicate (include) QCL information of a given channel/signal (for example, PDSCH, PDCCH, PUCCH or PUSCH).

The TCI-state is identified by a given identifier (TCI-state ID (TCI-StateId)), which may indicate (include) information related to QCL (QCL-Info) of a target channel/signal (or the reference signal for the reference signal) (or the antenna port of the reference signal) and another signal (for example, another downlink reference signal (DL-RS).

The QCL information may include, for example, at least one of information related to a DL-RS in a QCL relationship with the target channel/signal (DL-RS related information), information indicating the QCL type (QCL type information), and information related to the carrier (cell) where the DL-RS is arranged and BWP.

The DL-RS related information may include information indicating at least one of the DL-RS in a QCL relationship with the target channel/signal and the resource of the DL-RS. For example, when a plurality of reference signal sets (RS sets) is set in the user terminal, the DL-RS related information may indicate at least one of a DL-RS among the RSs included in the RS sets in a QCL relationship with a channel (or the port for the channel) and the resource for the DL-RS.

The DL-RS may be, for example, at least one of a synchronization signal (SS), physical broadcast channel (PBCH), synchronization signal block (SSB), mobility RS (MRS), channel state information reference signal (CSI-RS), CSI-RS for tracking, and beam-specific signal, or a signal configured by expanding or changing these signals (for example, a signal configured by changing at least one of the density and the period).

The synchronization signal may be, for example, at least one of a primary synchronization signal (PSS) and a secondary synchronization signal (SSS). The SSB is a signal block including a synchronization signal and a broadcast channel, and may be called SS/PBCH block or the like.

<TCI-State for PDCCH>

The TCI-state for PDCCH may include QCL information related to the QCL of PDCCH. Specifically, the TCI-state may include QCL information related to QCL of PDCCH demodulation reference signal (DMRS) (the antenna port of the DMRS (DMRS port) or a group of DMRS ports (DMRS port group) and the DL-RS.

One or more TCI-states may be configured for each control resource set (CORESET) preset in the user terminal. Also, if one or more TCI-states is configured per CORESET, a single TCI-state may be activated.

The user terminal may determine the QCL related to the PDCCH based on the TCI-state associated with CORESET (or activated). Specifically, assuming that the DMRS of the PDCCH (DMRS port or DMRS port group) is in a QCL relationship with the DL-RS corresponding to the TCI-state, the user terminal may control PDCCH reception processing (for example, decoding, demodulation, and the like).

At least one of configuration and activation of one or more TCIs is performed by higher layer signaling. The higher layer signaling may be, for example, any of radio resource control (RRC) signaling, medium access control (MAC) signaling, broadcast information and so on, or a combination thereof.

For the MAC signaling, for example, a MAC control element (MAC CE), a MAC protocol data section (PDU), or the like may be used. The broadcast information may be, for example, a master information block (MIB), a system information block (SIB), remaining minimum system information (RMSI), or the like.

For example, one or more TCI-states for each CORESET may be configured by the RRC control element “TCI-StatesPDCCH”. Also, the activation or deactivation of the configured TCI-state may be controlled by the MAC CE.

Further, a given number (for example, three or less) of CORESETs may be configured for each bandwidth part (BWP) preset in the user terminal in the serving cell.

The BWP is a partial band set in a carrier (also called cell, serving cell, component carrier (CC), and the like), and is also called partial band. The BWP may have a BWP for an uplink (UL) (UL BWP, uplink BWP) and a BWP for a downlink (DL) (DL BWP, downlink BWP). Each BWP provided with the given number of CORESETs may be a DL BWP.

The CORESET may be associated with a search space including one or more PDCCH candidates. Each CORESET may be associated with one or more search spaces. The user terminal may monitor the search space (monitor) and detect the PDCCH (DCI).

The PDCCH candidate is a resource unit to which one PDCCH is mapped, and may be composed of, for example, a number of control channel elements (CCEs) according to the aggregation level. The search space may include a number of PDCCH candidates according to the aggregation level.

In the present disclosure, “monitoring of a CORESET”, “monitoring of a search space (or SS set)”, “monitoring of a PDCCH candidate (or a set of one or more PDCCH candidates (PDCCH candidate set))”, “monitoring of a downlink control channel (for example, PDCCH)”, and “monitoring of downlink control information (DCI)” may be replaced with each other. The “monitoring” may be replaced with “at least one of blind decoding and blind detection”.

<TCI-State for PDSCH>

The TCI-state for PDSCH may include QCL information related to the QCL of PDSCH. Specifically, the TCI-state may include QCL information related to the QCL of the DMRS of the PDSCH or the port of the DMRS and the DL-RS.

M (M≥1) TCI-states for PDSCH (QCL information for M PDSCHs) may be notified to (configured in) the user terminal by higher layer signaling. The number M of TCI-states configured in the user terminal may be limited by at least one of the UE capability and the QCL type of the user terminal.

The DCI used for PDSCH scheduling may include a given field indicating the TCI-state (QCL information for PDSCH) (also called, for example, a field for TCI, TCI field, TCI-state field or the like). The DCI may be used for PDSCH scheduling of one cell, and may also be called, for example, DL DCI, DL assignment, DCI format 1_0, DCI format 1_1, or the like.

The TCI field may be composed of a given number of bits (for example, three bits). Whether the TCI field is included in the DCI may be controlled by the information from the base station to the UE. The information may be information indicating whether a TCI field is present or absent in the DCI (TCI-PresentInDCI). The TCI-PresentInDCI may be set in the user terminal, for example, by higher layer signaling (information element (IE) of RRC).

When the DCI includes a TCI field of x bits (e.g., x=3), the base station may configure in advance up to 2^{x} (e.g., x=3, 8) types of TCI-states in the user terminal using higher layer signaling. The value of the TCI field in the DCI (TCI field value) may indicate one of the TCI-states configured in advance by higher layer signaling.

When more than eight types of TCI-states are configured in the user terminal, eight or less types of TCI-states may be activated (designated) using MAC CE. The value of the TCI field in the DCI may indicate one of the TCI-states activated by the MAC CE.

The user terminal may determine the QCL for PDSCH based on the TCI-state indicated by the TCI field value in the DCI. Specifically, assuming that the DMRS of the PDSCH (DMRS port or DMRS port group) is in a QCL relationship with the DL-RS corresponding to the TCI-state notified by the DCI, the user terminal may control PDSCH reception processing (for example, decoding, demodulation, and the like).

When the TCI-PresentInDCI for CORESET for scheduling the PDSCH is valid, the user terminal may assume that the TCI field is present (included) in the DL DCI of the PDCCH transmitted in the CORESET.

When the TCI-PresentInDCI for CORESET for scheduling the PDSCH is invalid or the PDSCH is scheduled by DCI format 1_0, the user terminal may assume in the determination of the antenna port QCL of the PDSCH that the TCI-state for the PDSCH is identical to the TCI-state applied to the CORESET used for the transmission of the PDCCH. The antenna port (port) in the present disclosure may be interpreted as an antenna port group (port group).

(Spatial Relation Information)

For the future wireless communication system, it is considered that the user terminal controls at least one of processes of transmission of the uplink channel/signal (for example, encoding, modulation, and mapping), based on a spatial relation between at least one of an uplink channel (for example, PUCCH or PDSCH) and an uplink signal and a standard reference signal (standard RS).

The spatial relation corresponds to the spatial association between the uplink channel/signal and the standard RS. Based on the spatial relation, the user terminal can transmit the uplink channel/signal using the identical beam as the standard RS that is in the identical spatial relation with the uplink channel/signal.

The standard RS may be at least one of SSB, CSI-RS, a sounding reference signal (SRS), a beam-specific signal, and the like, or a signal configured by expanding or changing these signals (for example, a signal configured by changing at least one of the density and period).

Information indicating the spatial relation (also called spatial relation information (spatialRelationInfo) or the like) may include information indicating at least one of the following:
Identifier (pucch-SpatialRelationInfoId) of the spatial relation information;
Reference signal in the spatial relation with the uplink channel (e.g. SSB index, CSI-RS resource (e.g. non-zero power CSI-RS) identifier, SRS resource identifier, or the like);
Standard RS (PUCCH-PathlossReferenceRS) used for calculation of path-loss for transmission power control of the uplink channel (e.g. PUCCH) (e.g. at least one of one or more SSB indexes and CSI-RS configured index);
Parameter (p0-PUCCH) for open-loop control of transmission power of the uplink channel (e.g. PUCCH); and
Time position (e.g. K_{PUCCH,1}) of the TPC command (Δ_{PUCCH}) for closed-loop control of the transmission power for a transmission period i of the uplink channel (e.g. PUCCH).

The “spatial relation information” may be restated as the TCI-state, QCL, QCL relation, QCL information, SRS resource indicator (SRI), and the like.

The user terminal may have one or more pieces of spatial relation information (for example, one or more pieces of spatial relation information per uplink BWP of the serving cell) configured by higher layer signaling. When the one or more pieces of spatial relation information are configured by RRC signaling, the user terminal may have one piece of spatial relation information activated by a MAC CE.

However, as shown in FIGS. 1A and 1B, when PDSCH is transmitted from a different TRP at each given number of repetitions, there is a problem with how to feed the delivery acknowledgment information back to the PDSCH (also called HARQ-ACK, ACK or NACK, A/N, or the like).

Therefore, the present inventors have studied a method of, when PDSCH is repetitively transmitted from a different TRP, appropriately controlling the feedback of HARQ-ACK to the PDSCH, and have reached the present invention.

Now, the present embodiment will be described below in detail with reference to the drawings. Hereinafter, an example will be described in which a PDSCH is transmitted from a different TRP at each repetition. However, as described above, the PDSCH may be transmitted by a different TRP at each given number of repetitions (one or more repetitions), and a HARQ-ACK may be fed back to a different TRP at each given number of repetitions.

The following description will be focused on an example in which PDSCH repetitive transmission is performed using different resources in the time domain. However, as described above, PDSCH repetitive transmission is performed using different resources in at least one of the time domain and the frequency domain. Hereinafter, “PDSCH” and “DCI” may be paraphrased as each other.

In the following description, “transmitting a plurality of channels/signals from different TRPs” is synonymous with different TCI-states (also called QCL or QCL information) among the plurality of channels/signals. In the case of receiving a plurality of channels/signals having different TCI-states, the user terminal may assume that the plurality of channels/signals is transmitted from different TRPs. Therefore, “receiving a channel/signal transmitted from a different transmission and reception point at each given number of repetitions” is synonymous with receiving a channel/signal having a different TCI-state (also called QCL or QCL information) at each given number of repetitions.

In the following description, “transmitting a plurality of channels/signals to different TRPs” is synonymous with different spatial relation information among the plurality of channels/signals. In the case of transmitting a plurality of channels/signals based on the different spatial relation information, the user terminal may assume that the plurality of channels/signals is transmitted to different TRPs. Therefore, “transmitting a channel/signal to a different transmission and reception point at each given number of repetitions” is synonymous with receiving a channel/signal having different spatial relation information at each given number of repetitions.

(First Aspect)

In relation to the first aspect, an example will be described in which, when a PDSCH is transmitted from a plurality of different TRPs at each repetition (or in a plurality of TCI-states) (when the user terminal receives the PDSCH based on a different TCI-state at each repetition), a HARQ-ACK is transmitted using a PUCCH to a different TRP at each repetition (using different spatial relation information at each repetition).

The spatial relation information of the PUCCH may be designated at each repetition (the user terminal may receive the spatial relation information corresponding to each repetition). For example, when the geographic relations between the different TRPs and the UE are different, the spatial relation information may be different at each repetition.

Further, a HARQ-ACK at each repetition may be transmitted using a PUCCH resource assigned in common (identically) between the repetitions (a first HARQ-ACK feedback), or may be transmitted using a PUCCH resource assigned individually (separately) at each repetition (a second HARQ-ACK feedback).

The PUCCH resource is a resource used for transmitting the PUCCH. The PUCCH resource may include at least one of the following:
Time domain resource (e.g. the number of symbols) assigned to the PUCCH;
Starting position in the time domain of the PUCCH (for example, a starting symbol);
Initial cyclic shift (CS) interval (initial CS interval);
Information indicating whether frequency hopping is enabled for the PUCCH;
Frequency domain resource assigned to the PUCCH (e.g. physical resource block (PRB);
Initial cyclic shift (CS) index;
Orthogonal spreading code in the time domain (e.g. orthogonal cover code (OCC) index;
the length of the OCC used for block-wise spreading before discrete Fourier transform (DFT);
OCC index used for block-wise spreading after DFT;
the number of PRBs assigned to the PUCCH; and
The index of the frequency domain resource of the second hop when frequency hopping is enabled.

The user terminal may have one or more sets (PUCCH resource sets) each including one or more PUCCH resources configured by higher layer signaling. The user terminal may select the PUCCH resource set based on the number of bits of uplink control information (UCI) including the HARQ-ACK. The user terminal may determine the PUCCH resource used for transmission of the UCI from the PUCCH resource set, based on at least one of a given field and an implicit index (e.g. CCE index) in the DCI.

Hereinafter, the given field in the DCI used to determine the PUCCH resource will be called an ACK/NACK resource indicator (ARI) field, but the name of the given field is not limited to this. The given field may also be called, for example, PUCCH resource identifier (PUCCH resource indicator) field, ACK/NACK resource offset (ARO), TPC command field, or the like. In the following description, the implicit index is described as, for example, the minimum CCE index to which the DCI is assigned, but the present invention is not limited to this. The implicit index may be any information other than explicitly signaled information.

<First HARQ-ACK Feedback>

In the first HARQ-ACK feedback, the identical PUCCH resource is used between the repetitions of transmitting HARQ-ACK at each PDSCH repetition. The identical PUCCH resource may be determined based on at least one of the ARI field and CCE index in the DCI. The DCI may be, for example, a DCI that schedules PDSCHs with repetition coefficients K at all repetitions.

On the other hand, for transmission of HARQ-ACK at each repetition of the PDSCH, spatial relation information that is separately assigned between the repetitions may be used. The spatial relation information may be determined by at least one of higher layer signaling and DCI.

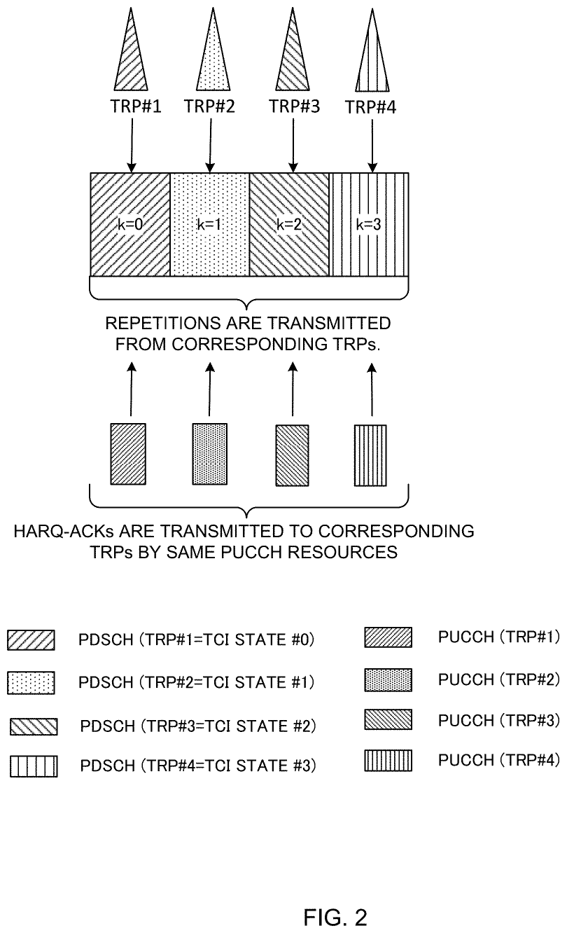

FIG. 2 is a diagram to show an example of first HARQ-ACK feedback according to the first aspect. FIG. 2 shows an example in which the PDSCH repetition coefficient K is 4. Referring to FIG. 2, the respective repetitions identified by repetition indexes k=0, 1, 2, and 3 are transmitted by TRPs #1, #2, #3, and #4, respectively.

Referring to FIG. 2, a case will be described as an example in which TCI-state IDs #0, #1, #2, and #3 of the PDSCHs are associated with the repetition indexes k=0, 1, 2, and 3, respectively. FIG. 2 shows a mere example, and the TCI-state IDs may be associated with RV indexes p. The following description will focus on differences from the examples in FIGS. 1A and 1B.

As shown in FIG. 2, when a PDSCH is transmitted from a different TRP at each repetition, a HARQ-ACK at each repetition may be transmitted to the corresponding TRP. For example, referring to FIG. 2, the HARQ-ACKs of the PDSCHs with the repetition indexes k=0, 1, 2, and 3 are respectively fed back to the TRPs #1, #2, #3, and #4 that transmitted the PDSCHs.

Referring to FIG. 2, the PUCCH resource used for transmitting the HARQ-ACKs to the TRPs may be identical. The user terminal may determine the identical PUCCH resource based on at least one of the ARI field and the CCE index in the DCI. The DCI may be, for example, a single DCI that collectively schedules the PDSCHs with the repetition indexes k=0, 1, 2, and 3.

On the other hand, the spatial relation information of the PUCCHs used for transmitting the HARQ-ACKs to the TRPs may be different or identical. The spatial relation information may be configured in the user terminal by higher layer signaling (e.g. RRC signaling) for each TRP (each repetition or each PUCCH), or may be designated by the DCI.

<<Configuration of Spatial Relation Information by Higher Layer Signaling>>

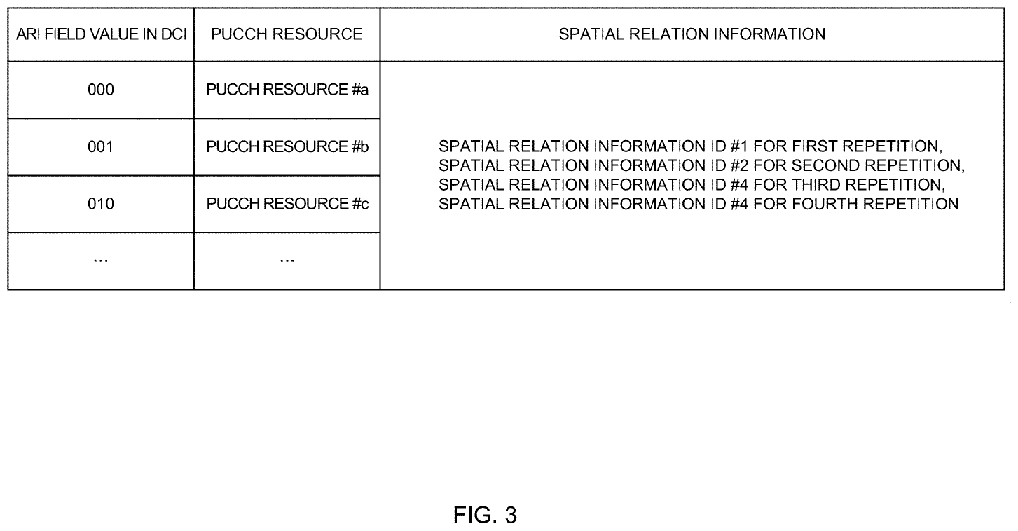

FIG. 3 is a diagram to show an example of setting of spatial relation information using higher layer signaling in the first HARQ-ACK feedback according to the first aspect. Referring to FIG. 3, the ARI field in the DCI has 3 bits, but the number of bits in the ARI field is not limited to this.

As shown in FIG. 3, the user terminal determines the PUCCH resource indicated by the value of the ARI field in the DCI as “the identical PUCCH resource used for transmitting the HARQ-ACKs to the TRPs”. For example, when the value of the ARI field in the DCI that schedules collectively the PDSCHs with the repetition indexes k=0, 1, 2, and 3 is “000”, the user terminal may use PUCCH resource #a to transmit the HARQ-ACKs to the PDSCHs with the repetition indexes k=0, 1, 2, and 3.

On the other hand, referring to FIG. 3, the user terminal has the spatial relation information of the PUCCHs configured in the user terminal by higher layer signaling (for example, RRC signaling) at each repetition (each TRP or each PUCCH). Therefore, regardless of which PUCCH resource is specified by the value of the ARI field in the DCI, the spatial relation information at each repetition is semi-statically fixed.

In this way, referring to FIG. 3, the PUCCH resource is specified based on the ARI field in the DCI that collectively schedules PDSCHs with the repetition coefficients K, and spatial relation information for the PUCCH is set by higher layer signaling. For this reason, different PUCCH resources may be assigned between PDSCHs with the repetition coefficients K scheduled by different DCIs. On the other hand, the spatial relation information of the PUCCH is fixed semi-statically, so it is fixed regardless of the value of the ARI field in the DCI.

<<Setting of the Spatial Relation Information by the DCI>>

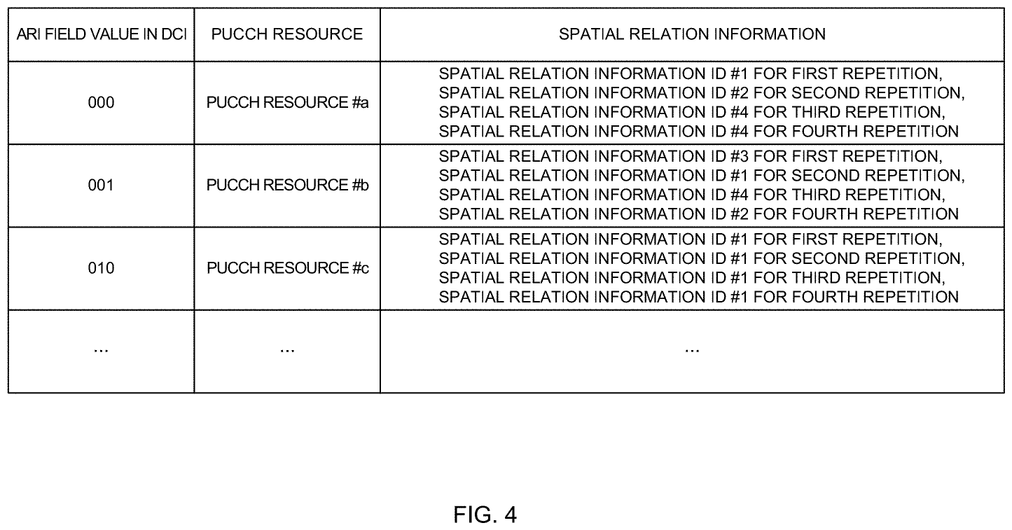

FIG. 4 is a diagram to show an example of setting of spatial relation information using DCI in the first HARQ-ACK feedback according to the first aspect. FIG. 4 differs from FIG. 3 in that each value of the ARI field in the DCI indicates not only the PUCCH resource but also the spatial relation information for each repetition (for each TRP or each PUCCH). Differences from FIG. 3 will be mainly described with reference to FIG. 4.

Each PUCCH resource may be associated with the spatial relation information of the PUCCH for each repetition (the spatial relation information of the PUCCH used to transmit a HARQ-ACK to each TRP) by higher layer signaling.

As shown in FIG. 4, the user terminal determines the spatial relation information of the PUCCH for each repetition based on the value of the ARI field in the DCI. Specifically, the user terminal may determine the spatial relation information associated with the PUCCH resource determined based on the ARI field in the DCI.

In this way, referring to FIG. 4, not only the PUCCH resource but also the spatial relation information for the PUCCH are specified based on the ARI field in the DCI that collectively schedules PDSCHs with the repetition coefficients K. For this reason, different PUCCH resources may be assigned between PDSCHs with the repetition coefficients K scheduled by different DCIs. In addition, between the PDSCHs with repetition coefficients K scheduled by different DCIs, different spatial relation information can be used even for the PUCCHs to the same TRP.

In the HARQ-ACK feedback, since the PUCCH resources are in common between the repetitions, even when a HARQ-ACK is fed back at each repetition, the determination of PUCCH resources in the user terminal can be simplified.

<Second HARQ-ACK Feedback>

In the second HARQ-ACK feedback, PUCCH resources that are individually assigned between repetitions may be used for transmitting a HARQ-ACK at each PDSCH repetition. The PUCCH resource at each repetition may be determined based on at least one of the ARI field and the CCE index in the DCI. The DCI may be, for example, a DCI that schedules the PDSCH with the repetition coefficient K at each repetition.

In addition, for transmission of HARQ-ACK at each repetition of the PDSCH, spatial relation information that is separately assigned between the repetitions is used. The spatial relation information may be determined by at least one of higher layer signaling and DCI.

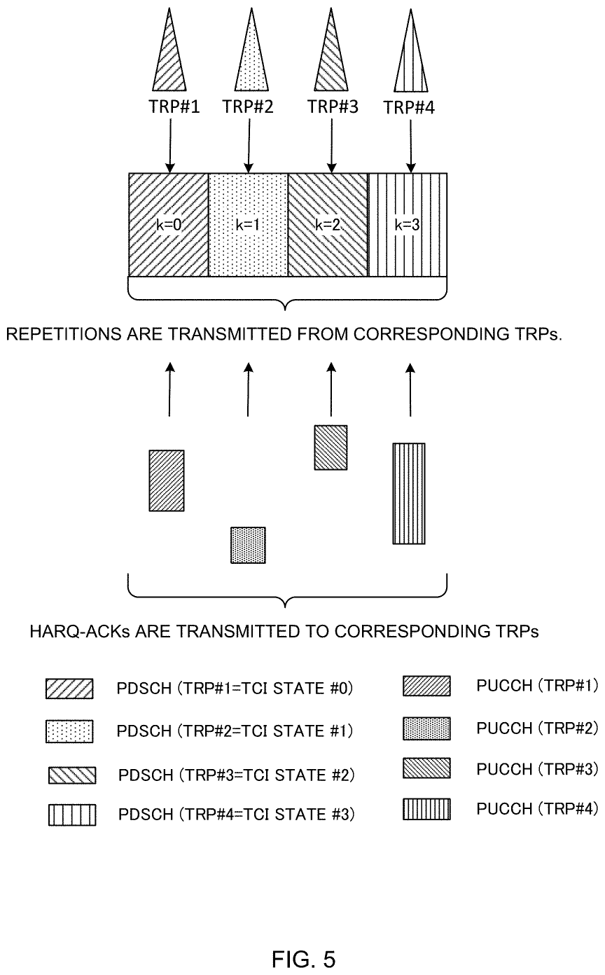

FIG. 5 is a diagram to show an example of second HARQ-ACK feedback according to the first aspect. FIG. 5 is different from FIG. 2 in that, when a PDSCH is transmitted from a different TRP at each repetition, a HARQ-ACK at each repetition is transmitted to each TRP using a different PUCCH resource at each repetition. Differences from FIG. 2 will be mainly described with reference to FIG. 5.

Referring to FIG. 5, the PUCCH resource used for transmitting the HARQ-ACKs to the TRPs may be different. The user terminal may determine the PUCCH resource at each repetition based on at least one of the ARI field and the CCE index in the DCI. The DCI may be, for example, a DCI that collectively schedules the PDSCHs with repetition indexes k=0, 1, 2, and 3, or a DCI that individually schedules the PDSCHs with repetition indexes k=0, 1, 2, and 3.

In addition, the spatial relation information of the PUCCHs used for transmitting the HARQ-ACKs to the TRPs may be different or identical. The spatial relation information may be configured in the user terminal by higher layer signaling (e.g. RRC signaling) for each TRP (each repetition or each PUCCH), or may be designated by the DCI.

<<Configuration of Spatial Relation Information by Higher Layer Signaling>>

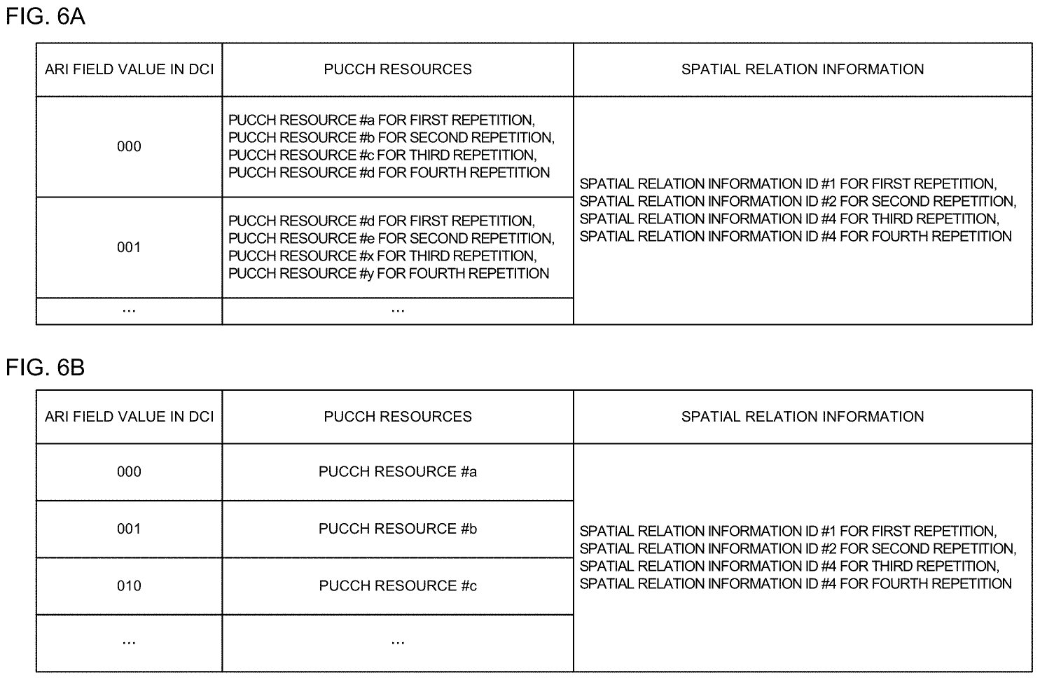

FIGS. 6A and 6B are diagrams to show an example of setting of spatial relation information using higher layer signaling in the second HARQ-ACK feedback according to the first aspect. Referring to FIGS. 6A and 6B, the ARI field in the DCI has 3 bits, but the number of bits in the ARI field is not limited to this.

Referring to FIG. 6A, the DCI that schedules the PDSCHs with repetition coefficients K for all repetitions will be described. As shown in FIG. 6A, each value of the ARI field in the DCI may indicate a PUCCH resource for each repetition (each TRP, each PUCCH, or each repetition index).

For example, when the value of the ARI field in the DCI is “000”, the user terminal may transmit a HARQ-ACK to the first PDSCH with the repetition coefficient K=4 (for example, the repetition index k=0 in FIG. 5) using a PUCCH resource #a. Similarly, the user terminal may transmit HARQ-ACKs to the second, third, and fourth PDSCHs (for example, the repetition indexes k=1, 2, and 3 in FIG. 5) using PUCCH resources #b, #c, and #d.

Referring to FIG. 6B, the DCI that schedules the PDSCH for each repetition with repetition coefficient K will be described. As shown in FIG. 6B, each value of the ARI field in the DCI may indicate a PUCCH resource for a target repetition (TRP, PUCCH, or repetition index).

For example, based on the value of the ARI field in the DCI that schedules the first PDSCH with the repetition coefficient K=4 (for example, the repetition index k=0 in FIG. 5), the user terminal may determine the PUCCH resource for use in the transmission of a HARQ-ACK to the first PDSCH. Similarly, the user terminal determines the PUCCH resources for use in the transmission of HARQ-ACKs to the second and subsequent PDSCHs.

In addition, referring to FIGS. 6A and 6B, the user terminal has the spatial relation information of the PUCCHs configured in the user terminal by higher layer signaling (for example, RRC signaling) at each repetition (each TRP or each PUCCH). Therefore, regardless of which PUCCH resource is specified by the value of the ARI field in the DCI, the spatial relation information at each repetition is semi-statically fixed.

In this way, referring to FIGS. 6A and 6B, a different PUCCH resource can be assigned at each repetition based on the ARI field value in the DCI. On the other hand, the spatial relation information of the PUCCH is fixed semi-statically, so it is fixed regardless of the value of the ARI field in the DCI.

<<Setting of the Spatial Relation Information by the DCI>>

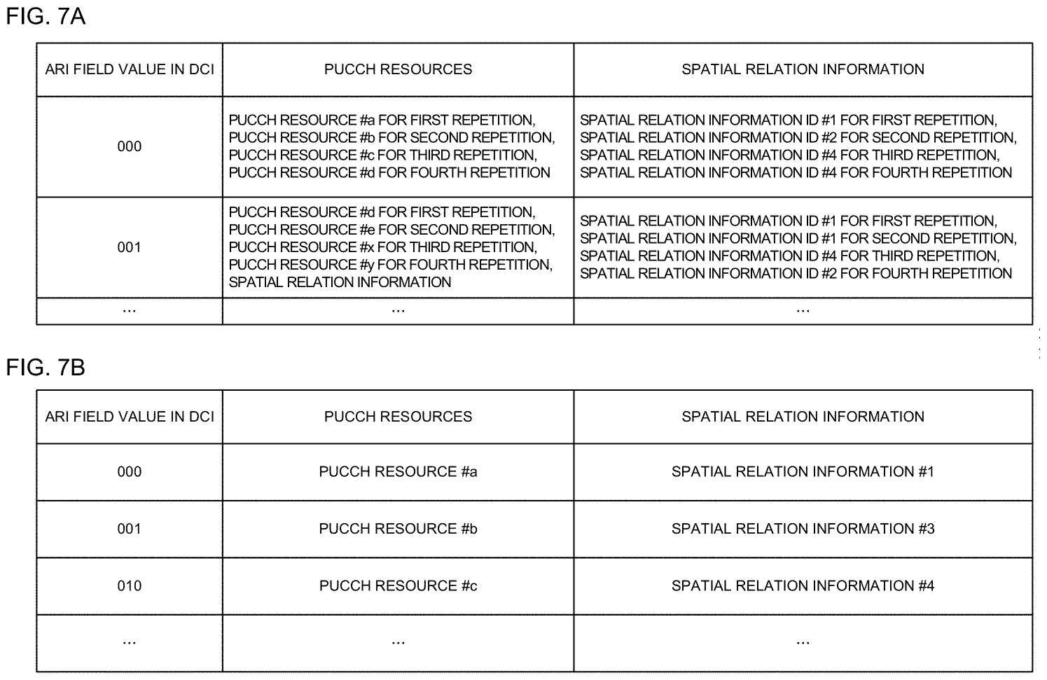

FIGS. 7A and 7B are diagrams to show an example of setting of spatial relation information using DCI in the second HARQ-ACK feedback according to the first aspect. FIGS. 7A and 7B differ from FIGS. 6A and 6B in that each value of the ARI field in the DCI indicates not only the PUCCH resource but also the spatial relation information for each repetition (for each TRP or each PUCCH). Referring to FIGS. 7A and 7B, differences from the examples in FIGS. 6A and 6B will be mainly described.

Referring to FIG. 7A, the DCI that schedules the PDSCHs for all repetitions with repetition coefficients K will be described. Each PUCCH resource for each repetition indicated by each value in the ARI field in the DCI (each TRP or each repetition index) may be associated with the spatial relation information of the PUCCH for each repetition (the spatial relation information of the PUCCH used to transmit a HARQ-ACK to each TRP) by higher layer signaling.

For example, referring to FIG. 7A, the user terminal may determine the PUCCH resource at each repetition based on the value of the ARI field in the DCI. Specifically, the user terminal may determine the spatial relation information based on the value of the ARI field, or may determine the spatial relation information associated with the PUCCH resource by higher layer signaling.

Referring to FIG. 7B, the DCI that schedules the PDSCH for each repetition with repetition coefficient K will be described. As shown in FIG. 7B, each value of the ARI field in the DCI may indicate a PUCCH resource for a target repetition (TRP, PUCCH, or repetition index). The PUCCH resource may be associated with the spatial relation information of the PUCCH (the spatial relation information of the PUCCH used to transmit a HARQ-ACK to each TRP) by higher layer signaling.

Referring to FIG. 7B, the user terminal may determine the PUCCH resource to be used for transmitting a HARQ-ACK to the PDSCH, based on the value of the ARI field in the DCI that schedules the PDSCH at each repetition. Also, the user terminal may determine the spatial relation information based on the value of the ARI field, or may determine the spatial relation information associated with the PUCCH resource by higher layer signaling.

In the second HARQ-ACK feedback, PUCCH resources are separately assigned among repetitions. Therefore, when a HARQ-ACK is fed back at each repetition, the PUCCH resources can be controlled more flexibly than in the first HARQ-ACK feedback.

(Second Aspect)

The second aspect is different from the first aspect in that, when PDSCHs are transmitted from a plurality of different TRPs at each repetition (or in a plurality of TCI-states) (when the user terminal receives the PDSCHs based on the different TCI-states at each repetition), instead of a HARQ-ACK being fed back at each repetition, a synthesis result of HARQ-ACKs is fed back at each repetition. The following description will focus on differences from the first aspect.

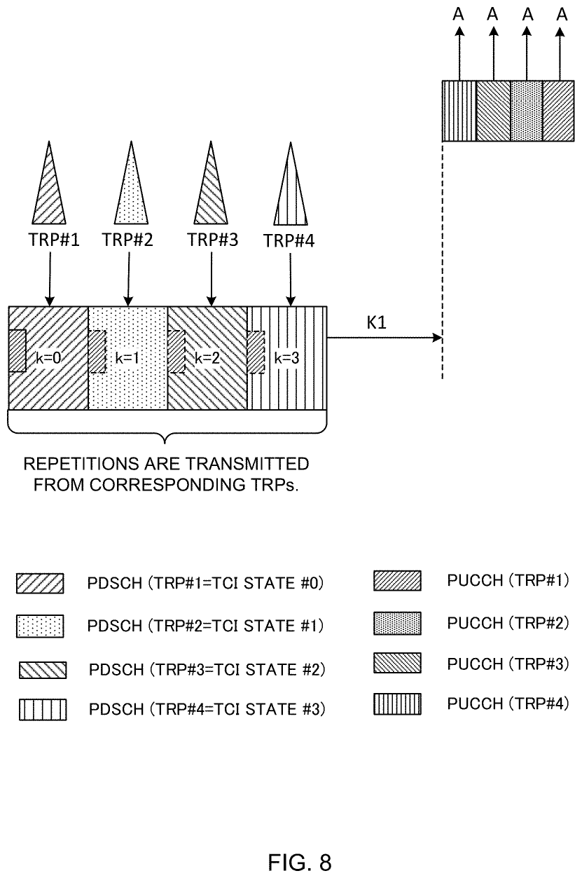

FIG. 8 is a diagram to show an example of HARQ-ACK feedback according to the second aspect. Differences from FIG. 2 will be mainly described with reference to FIG. 8. As shown in FIG. 8, when PDSCHs with repetition indexes k=0, 1, 2, and 3 are transmitted by TRP #1, #2, #3, and #4, respectively, HARQ-ACKs to the corresponding PDSCHs may be synthesized.

For example, when at least one repetitive decoding of the PDSCH with repetition coefficient K (here, K=4) is successful, the user terminal may feed back a 1-bit HARQ-ACK indicating ACK. On the other hand, if all repetitive decoding fails, the user terminal may feed back a 1-bit HARQ-ACK indicating NACK.

The user terminal may repetitively transmit the 1-bit HARQ-ACK indicating ACK or NACK to each of a plurality of TRPs (here, TRPs #1 to #4) using a PUCCH.

The PUCCH resource used for transmitting the HARQ-ACK may be identical among the plurality of TRPs (among the repetitions or repetition indexes) (see the first HARQ-ACK feedback in the first aspect), or individual PUCCH resources may be assigned (see the second HARQ-ACK feedback in the first aspect).

The spatial relation information of the PUCCH used for transmitting the HARQ-ACK may be assigned by at least one of higher layer signaling (for example, RRC signaling) and DCI for each TRP (each repetition or each repetition index).

As shown in FIG. 8, the user terminal may transmit the 1-bit HARQ-ACK to the plurality of TRPs after a given period K1 from the last repetition (here, the repetition index k=3). The given period K1 may be defined in advance in specifications, or may be specified by at least one of higher layer signaling and DCI.

Referring to FIG. 8, the 1-bit HARQ-ACK is fed back in the order of TRPs #4, #3, #2, and #1, but the feedback order is not limited to this. As shown in FIG. 8, when a feedback is first provided to the TRP that transmits the last repetition of PDSCH (here, the TRP #4), the last reception beam of the PDSCH and the first transmission beam of the HARQ-ACK are the same, thereby making it possible to reduce the burden of beam sweep (for example, in the case of analog beam forming).

In the second aspect, the synthesis result of HARQ-ACK for each repetition is repetitively fed back to the plurality of TRPs. Accordingly, the plurality of TRPs that transmit PDSCHs with the repetition coefficients K can easily recognize whether there is need for retransmission of the PDSCHs.

In the second aspect, the 1-bit HARQ-ACK that is a synthesis of decoding results of the PDSCHs for each repetition is fed back to the plurality of TRPs that has transmitted the PDSCHs. However, the present invention is not limited to this but the 1-bit HARQ-ACK may be fed back to a signal TRP. The single TRP may be, for example, a primary TRP (also called primary cell (PCell) or primary secondary cell (PSCell)).

(Third Aspect)

The third aspect is identical to the first aspect in that, when PDSCHs are transmitted from a plurality of different TRPs at each repetition (or in a plurality of TCI-states), a HARQ-ACK for each repetition is fed back, but is different from the first aspect in that the HARQ-ACK for each repetition is fed back to a single TRP. The following description will focus on differences from the first aspect.

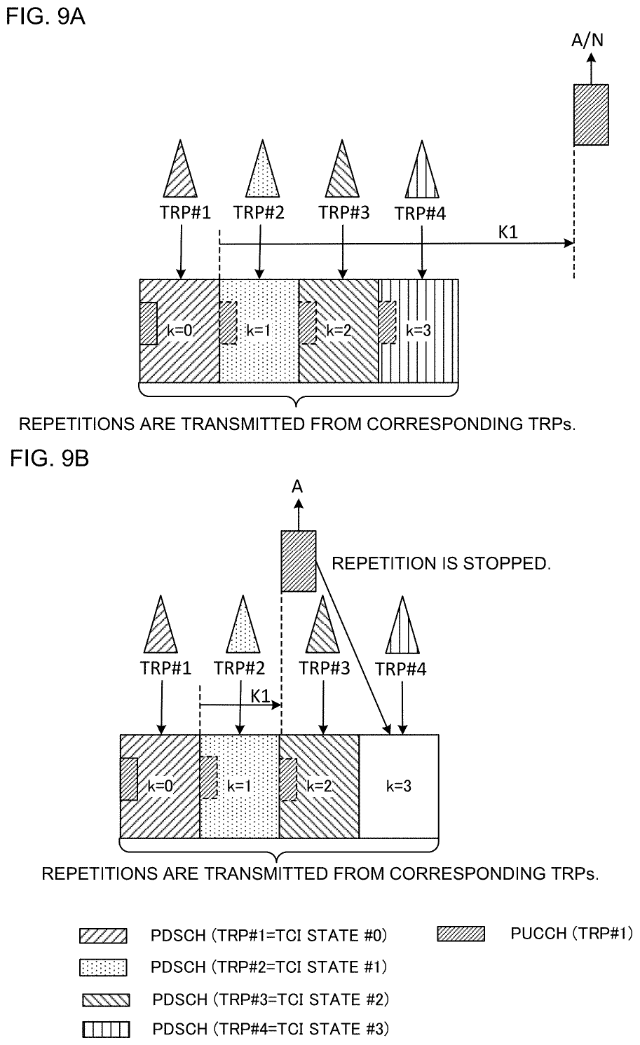

FIGS. 9A and 9B are diagrams to show examples of HARQ-ACK feedback according to the third aspect. Referring to FIGS. 9A and 9B, differences from the examples in FIGS. 2 and 5 will be mainly described.

As shown in FIG. 9A, the user terminal may receive repetitive PDSCHs and feed back a HARQ-ACK for the PDSCHs to a single TRP after a given period K1 from the reception. The given period K1 may be defined in advance in specifications, or may be specified by at least one of higher layer signaling and DCI.

The single TRP may be the above-mentioned primary TRP, or may be a TRP (also called serving cell, cell, or the like) in which the user terminal has first detected the DCI to schedule the PDSCHs.

As shown in FIG. 9B, if the given period K1 is within the repetition period (repetition window) of a PDSCH with the repetition coefficient K, repetitive transmission from another TRP may be stopped based on the HARQ-ACK indicating ACK. On the assumption that the repetitive transmission of data corresponding to the ACK will not be performed after a lapse of a given time since transmitting the HARQ-ACK indicating the ACK, the user terminal may not perform the reception signal process on repetitions after the lapse of the given time.

For example, referring to FIG. 9B, the user terminal succeeds in decoding the PDSCH with the repetition index k=0, and feeds back an ACK to the TRP #1 after the given period K1 from the reception of the PDSCH.

Referring to FIG. 9B, upon receipt of the ACK from the user terminal, the TRP #1 may transmit, to the TRP #4, instruction information for instructing to stop the transmission of the PDSCH at the last repetition (the repetition index k=3). The TRP #4 may stop transmission of the PDSCH also based on the instruction information from the TRP #1. In this case, the TRP #1 and TRP #4 may be connected via an ideal interface such as an optical line.

Referring to FIGS. 9A and 9B, the PUCCH resource used for feedback of a HARQ-ACK at each repetition may be the same (see the first HARQ-ACK feedback in the first aspect), or individual PUCCH resources may be assigned (see the second HARQ-ACK feedback in the first aspect).

Further, in the case of feeding back the HARQ-ACK at each repetition to the same TRP, the spatial relation information of the PUCCH used for transmitting each HARQ-ACK may be the same. The spatial relation information may be assigned by at least one of higher layer signaling (for example, RRC signaling) and DCI.

In the third aspect, since a HARQ-ACK for each repetition is fed back to a single TRP, the single TRP can intensively perform a retransmission control based on the HARQ-ACK.

(Fourth Aspect)

The fourth aspect is identical to the first aspect in that, when PDSCHs are transmitted from a plurality of different TRPs at each repetition (or in a plurality of TCI-states), a HARQ-ACK for each repetition is fed back, but is different from the first aspect in that the HARQ-ACKs for all repetitions are fed back to the plurality of TRPs. The following description will focus on differences from the first aspect.

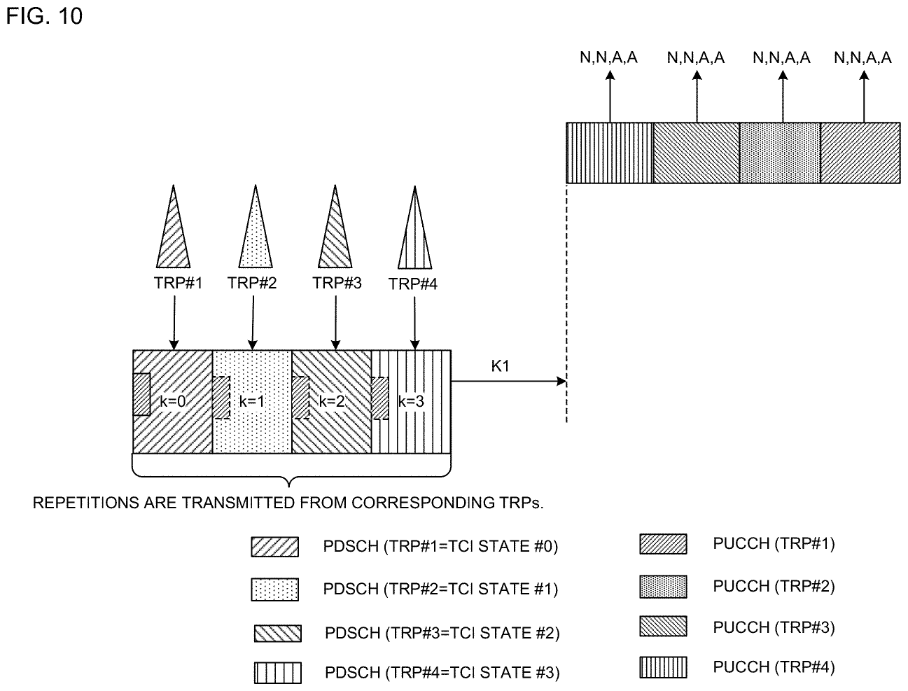

FIG. 10 is a diagram to show an example of HARQ-ACK feedback according to the fourth aspect. Differences from FIGS. 2 and 5 will be mainly described with reference to FIG. 10.

As shown in FIG. 10, when PDSCHs with repetition indexes k=0, 1, 2, and 3 are transmitted by TRPs #1, #2, #3, and #4, respectively, HARQ-ACKs for the PDSCHs may be transmitted to the TRPs #4, #3, #2, and #1 that have transmitted the PDSCHs, respectively.

For example, referring to FIG. 10, decoding of the PDSCHs with the repetition indexes k=0 and 1 fails, and decoding of the PDSCHs with the repetition indexes k=2 and 3 succeeds. Therefore, the user terminal transmits 4-bit HARQ-ACKs indicating NACK, NACK, ACK, and ACK to the TRPs #4, #3, #2, and #1 that have transmitted the PDSCHs with the repetition indexes k=3, 2, 1, and 0, respectively.

As shown in FIG. 10, the user terminal may transmit the 1-bit HARQ-ACK to the plurality of TRPs after a given period K1 from the last repetition (here, the repetition index k=3). The given period K1 may be defined in advance in specifications, or may be specified by at least one of higher layer signaling and DCI.

When the HARQ-ACKs having the same number of bits as the repetition coefficient K (here, K=4) are fed back to the plurality of TRPs, the feedback order is not limited to that shown in FIG. 10. As shown in FIG. 10, when a feedback is first provided to the TRP that transmits the last repetition of PDSCH (here, the TRP #4), the last reception beam of the PDSCH and the first transmission beam of the HARQ-ACK are the same, thereby making it possible to reduce the burden of beam sweep (for example, in the case of analog beam forming).

Referring to FIG. 10, the PUCCH resource used for feedback of the HARQ-ACKs having the same number of bits as the repetition coefficient K may be the same (see the first HARQ-ACK feedback in the first aspect), or individual PUCCH resources may be assigned (see the second HARQ-ACK feedback in the first aspect).

The spatial relation information of the PUCCHs used for transmitting the HARQ-ACKs may be assigned by at least one of higher layer signaling (for example, RRC signaling) and DCI at each repetition (each PUCCH or each repetition index).

In the fourth aspect, the HARQ-ACKs with the same number of bits as the repetition coefficient K (HARQ-ACKs for all repetitions) are fed back to the plurality of TRPs, so that, even if any TRP fails to detect the HARQ-ACK, the retransmission control of the PDSCHs with the repetition coefficients K can be appropriately performed.

(Fifth Aspect)

The fifth aspect is identical to the first aspect in that, when PDSCHs are transmitted from a plurality of different TRPs at each repetition (or in a plurality of TCI-states), a HARQ-ACK for each repetition is fed back, but is different from the first aspect in that the HARQ-ACK for each repetition is fed back to the plurality of TRPs. The following description will focus on differences from the first aspect.

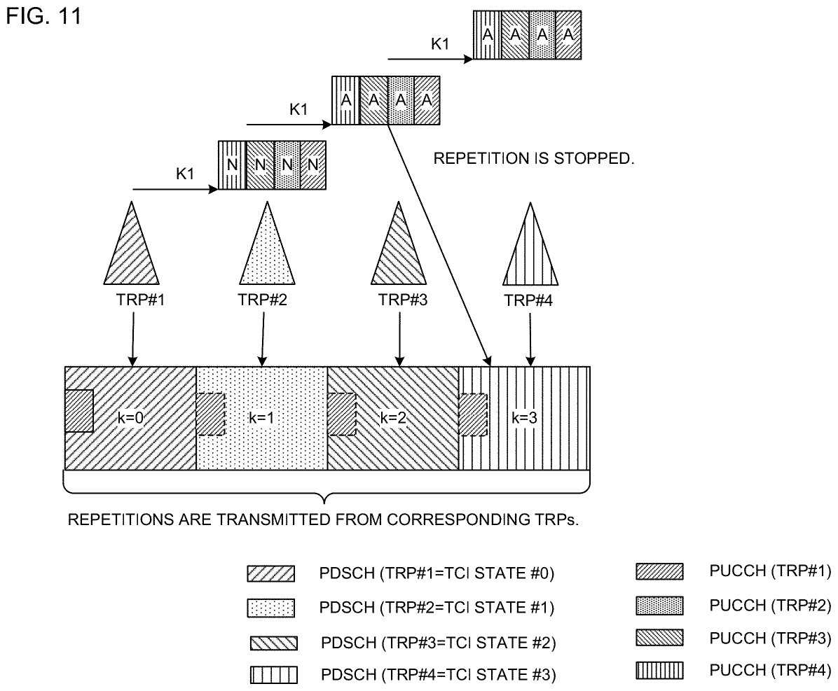

FIG. 11 is a diagram to show an example of HARQ-ACK feedback according to the fifth aspect. Differences from FIGS. 2 and 5 will be mainly described with reference to FIG. 11.

Referring to FIG. 11, after a given period K1 from receipt of the PDSCH at each repetition, the user terminal generates a HARQ-ACK having the same number of bits as the repetition coefficient K based on the decoding result of the received PDSCH, and feeds back the HARQ-ACK to different TRPs.

For example, referring to FIG. 11, when having failed to decode the PDSCH at the first repetition (repetition index k=0), the user terminal feeds back the HARQ-ACK indicating NACK with the repetition index k=0 to the plurality of TRPs #1, #2, #3, and #4 after the given period K1 from the receipt of the PDSCH.

In addition, referring to FIG. 11, when having succeeded in decoding the PDSCH at the second repetition (repetition index k=1), the user terminal feeds back the HARQ-ACK indicating ACK with the repetition index k=1 to the plurality of TRPs #1, #2, #3, and #4 after the given period K1 from the receipt of the PDSCH. Similarly, the user terminal feeds back the HARQ-ACK at each of the third and subsequent repetitions for the PDSCH with repetition index k to the plurality of TRPs.

Referring to FIG. 11, upon receipt of the HARQ-ACK (ACK) for the PDSCH at the second repetition (repetition index k=1), the TRP #4 may stop the transmission of the PDSCH at the fourth repetition (repetition index k=1).

Referring to FIG. 11, the PUCCH resource used for feedback of a HARQ-ACK at each repetition may be the same (see the first HARQ-ACK feedback in the first aspect), or individual PUCCH resources may be assigned (see the second HARQ-ACK feedback in the first aspect).

In addition, the spatial relation information of the PUCCHs used for transmitting the HARQ-ACKs to the TRPs may be different or identical. The spatial relation information may be assigned for each TRP by at least one of higher layer signaling (for example, RRC signaling) and DCI.

In the fifth aspect, since the HARQ-ACK at each repetition is fed back to all the TRPs performing PDSCH repetitive transmission, it is possible to stop the repetitive transmission of the PDSCH based on the HARQ-ACK within the repetition period (repetition window) of the PDSCHs with the repetition coefficient K.

(Radio Communication System)

Now, the structure of a radio communication system according to the present embodiment will be described below. In this radio communication system, communication is performed using one or a combination of the radio communication methods according to the embodiments of the present disclosure.

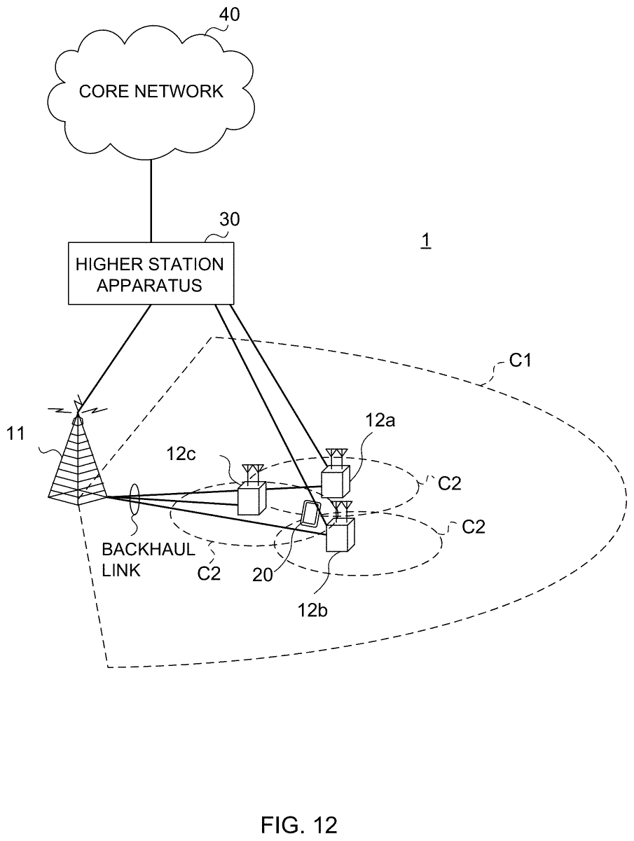

FIG. 12 is a diagram to show an example of a schematic structure of the radio communication system according to the present embodiment. A radio communication system 1 can adopt carrier aggregation (CA) and/or dual connectivity (DC) to group a plurality of fundamental frequency blocks (component carriers) into one, where the LTE system bandwidth (for example, 20 MHz) constitutes one unit.

The radio communication system 1 may be referred to as long term evolution (LTE), LTE-Advanced (LTE-A), LTE-beyond (LTE-B), SUPER 3G, IMT-Advanced, 4th generation mobile communication system (4G), 5th generation mobile communication system (5G), new radio (NR), future radio access (FRA), new-radio access technology (RAT), and the like, or may be referred to as a system that achieves these.

The radio communication system 1 includes a radio base station 11 that forms a macro cell C1 covering a relatively wide coverage, and radio base stations 12 (12a to 12c) that are placed within the macro cell C1 and that form small cells C2, which are narrower than the macro cell C1. Also, user terminals 20 are placed in the macro cell C1 and in each small cell C2. The arrangement, number and so on of cells and user terminals 20 are not limited to those illustrated in the drawings.

The user terminals 20 can connect with both the radio base station 11 and the radio base stations 12. It is assumed that the user terminals 20 uses the macro cell C1 and the small cells C2 at the same time using CA or DC. Furthermore, the user terminals 20 may apply CA or DC using a plurality of cells (CCs).

Between the user terminals 20 and the radio base station 11, communication can be carried out using a carrier of a relatively low frequency band (for example, 2 GHz) and a narrow bandwidth (referred to as an “existing carrier,” a “legacy carrier” and so on). Meanwhile, between the user terminals 20 and the radio base stations 12, a carrier of a relatively high frequency band (for example, 3.5 GHz, 5 GHz, and so on) and a wide bandwidth may be used, or the same carrier as that used between the user terminals 20 and the radio base station 11 may be used. The configuration of the frequency band for use in each radio base station is by no means limited to these.

Moreover, the user terminal 20 can perform communication in each cell using time division duplex (TDD) and/or frequency division duplex (FDD). Further, in each cell (carrier), a single numerology may be applied, or a plurality of different numerologies may be applied.

The numerology may be a communication parameter applied to transmission and/or reception of a signal and/or channel, and may indicate, for example, at least one of subcarrier spacing, bandwidth, symbol length, cyclic prefix length, subframe length, TTI length, number of symbols per TTI, radio frame configuration, specific filtering processing performed by a transceiver in a frequency domain, specific windowing processing performed by a transceiver in a time domain and so on. For example, for a certain physical channel, when the subcarrier spacing differs and/or the numbers of OFDM symbols are different between the constituent OFDM symbols, this case may be described that they are different in numerology.

The radio base station 11 and the radio base station (or between 2 radio base stations 12) may be connected by wire (for example, means in compliance with the common public radio interface (CPRI) such as optical fiber, an X2 interface, and so on) or wirelessly.

The radio base station 11 and the radio base stations 12 are each connected with higher station apparatus 30, and are connected with a core network 40 via the higher station apparatus 30. Note that the higher station apparatus 30 may be, for example, access gateway apparatus, a radio network controller (RNC), a mobility management entity (MME) and so on, but is by no means limited to these. Also, each radio base station 12 may be connected with the higher station apparatus 30 via the radio base station 11.

Note that the radio base station 11 is a radio base station having a relatively wide coverage, and may be referred to as a “macro base station”, an “aggregate node”, an “eNodeB (eNB)”, a “transmission and reception point”, and so on. Also, the radio base stations 12 are radio base stations having local coverages, and may be referred to as “small base stations,” “micro base stations,” “pico base stations,” “femto base stations,” “Home eNodeBs (HeNBs),” “Remote Radio Heads (RRHs),” “transmission and reception points” and so on. Hereinafter the radio base stations 11 and 12 will be collectively referred to as “radio base stations 10,” unless specified otherwise.

The user terminals 20 are terminals to support various communication schemes such as LTE, LTE-A and so on, and may be either mobile communication terminals (mobile stations) or stationary communication terminals (fixed stations).

In the radio communication system 1, as radio access schemes, orthogonal frequency division multiple access (OFDMA) is applied to the downlink, and single-carrier frequency division multiple access (SC-FDMA) and/or OFDMA are applied to the uplink.

OFDMA is a multi-carrier communication scheme to perform communication by dividing a frequency bandwidth into a plurality of narrow frequency bandwidths (subcarriers) and mapping data to each subcarrier. SC-FDMA is a single-carrier communication scheme to mitigate interference between terminals by dividing the system bandwidth into bands formed with one or continuous resource blocks per terminal, and allowing a plurality of terminals to use mutually different bands. Note that the uplink and downlink radio access schemes are not limited to the combinations of these, and other radio access schemes can be used as well.

In the radio communication system 1, a downlink shared channel (Physical Downlink Shared Channel (PDSCH)), which is used by each user terminal 20 on a shared basis, a broadcast channel (Physical Broadcast Channel (PBCH)), downlink L1/L2 control channels, and so on are used as downlink channels. User data, higher layer control information, and a system information block (SIB) are transmitted by the PDSCH. Further, a master information block (MIB) is transmitted by PBCH.

The downlink L1/L2 control channels include a physical downlink control channel (PDCCH), an enhanced physical downlink control channel (EPDCCH), a physical control format indicator channel (PCFICH), a physical hybrid-ARQ indicator channel (PHICH), and so on. Downlink control information (DCI), including PDSCH and/or PUSCH scheduling information, and so on, is transmitted by the PDCCH.

DCI that schedules receipt of DL data may also be referred to as “DL assignment,” and DCI that schedules transmission of UL data may also be referred to as “UL grant.”

The number of OFDM symbols to use for the PDCCH is communicated by the PCFICH. A hybrid automatic repeat request (HARQ) delivery acknowledgment information (also referred to as, for example, retransmission control information, HARQ-ACK, ACK/NACK, and so on) in response to the PUSCH is transmitted by the PHICH. The EPDCCH is frequency-division-multiplexed with the downlink shared data channel (PDSCH) and used for transmission of DCI and so on, like the PDCCH.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)), and so on are used as uplink channels. User data, higher layer control information, and so on are communicated by the PUSCH. Also, in the PUCCH, downlink radio quality information (Channel Quality Indicator (CQI)), delivery acknowledgment information, scheduling requests (SRs) and so on are communicated. By means of the PRACH, random access preambles for establishing connections with cells are communicated.

In the radio communication systems 1, cell-specific reference signal (CRSs), channel state information reference signal (CSI-RSs), demodulation reference signal (DMRSs), positioning reference signal (PRSs) and so on are communicated as downlink reference signals. Also, in the radio communication system 1, measurement reference signals (Sounding Reference Signals (SRSs)), demodulation reference signals (DMRSs), and so on are communicated as uplink reference signals. Note that, DMRSs may be referred to as “user terminal-specific reference signals (UE-specific Reference Signals)”. Also, the reference signals to be communicated are by no means limited to these.

<Radio Base Station>

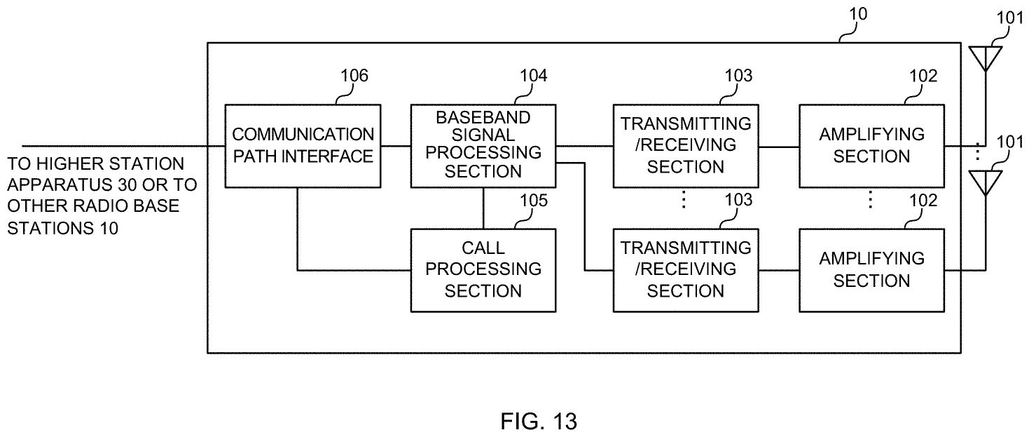

FIG. 13 is a diagram to show an example of an overall structure of the radio base station according to the present embodiment. A radio base station 10 has a plurality of transmitting/receiving antennas 101, amplifying sections 102, transmitting/receiving sections 103, a base band signal processing section 104, a call processing section 105 and a communication path interface 106. Note that one or more transmitting/receiving antennas 101, amplifying sections 102 and transmitting/receiving sections 103 may be provided.

User data to be transmitted from the radio base station 10 to a user terminal 20 on the downlink is input from the higher station apparatus 30 to the base band signal processing section 104, via the communication path interface 106.

In the base band signal processing section 104, the user data is subjected to transmission processing, including processing of a packet data convergence protocol (PDCP) layer, division and coupling of the user data, radio link control (RLC) layer transmission processing such as RLC retransmission control, medium access control (MAC) retransmission control (for example, HARQ transmission processing), scheduling, transmission format selection, channel coding, inverse fast Fourier transform (IFFT) processing, and precoding processing, and a result is transferred to each transmitting/receiving section 103. Furthermore, downlink control signals are also subjected to transmission processes such as channel coding and an inverse fast Fourier transform, and forwarded to the transmitting/receiving sections 103.

Each of the transmitting/receiving sections 103 converts a base band signal, which is pre-coded for each antenna and output from the base band signal processing section 104, into a signal in a radio frequency band, and transmits such a radio frequency signal. A radio frequency signal subjected to the frequency conversion in each transmitting/receiving section 103 is amplified in the amplifying section 102, and transmitted from each transmitting/receiving antenna 101. The transmitting/receiving sections 103 can be constituted by a transmitter/receiver, a transmitting/receiving circuit or transmitting/receiving apparatus that can be described based on general understanding of the technical field to which the present disclosure pertains. Note that a transmitting/receiving section 103 may be structured as a transmitting/receiving section in one entity, or may be constituted by a transmitting section and a receiving section.

Meanwhile, as for uplink signals, radio frequency signals that are received in the transmitting/receiving antennas 101 are each amplified in the amplifying sections 102. The transmitting/receiving sections 103 receive the uplink signals amplified in the amplifying sections 102. The received signals are converted into the base band signal through frequency conversion in the transmitting/receiving sections 103 and output to the base band signal processing section 104.

In the base band signal processing section 104, user data that is included in the uplink signals that are input is subjected to a fast Fourier transform (FFT) process, an inverse discrete Fourier transform (IDFT) process, error correction decoding, a MAC retransmission control receiving process, and RLC layer and PDCP layer receiving processes, and forwarded to the higher station apparatus 30 via the communication path interface 106. The call processing section 105 performs call processing (such as setting up and releasing communication channels), manages the state of the radio base stations 10 and manages the radio resources.

The communication path interface 106 transmits and receives signals to and from the higher station apparatus 30 via a given interface. Moreover, the communication path interface 106 may transmit and receive (perform backhaul signaling for) signals with other radio base stations 10 via an inter-base station interface (for example, optical fiber in compliance with common public radio interface (CPRI), and the X2 interface).

Note that the transmitting/receiving section 103 may further include an analog beam forming section that performs analog beam forming. The analog beam forming section may be composed of an analog beam forming circuit (for example, a phase shifter, a phase shift circuit) or an analog beam forming device (for example, a phase shifter), which is described based on common understanding in the technical field according to the present invention. Further, the transmitting/receiving antenna 101 may be composed of an array antenna, for example.

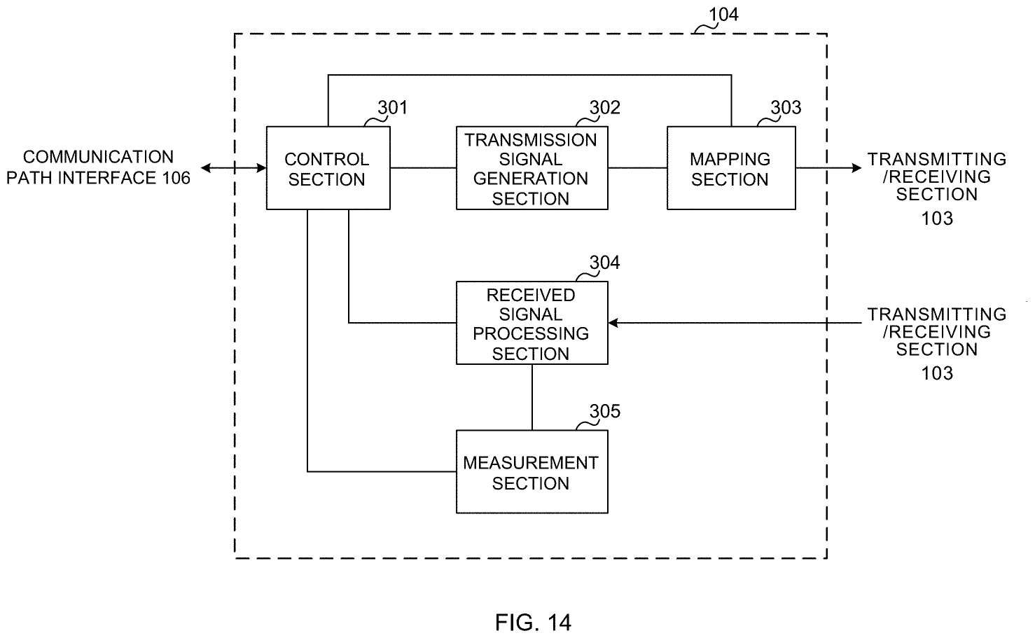

FIG. 14 is a diagram illustrating an example of a functional configuration of the radio base station according to the present embodiment. Note that, although this example will primarily show functional blocks that pertain to characteristic parts of the present embodiment, the radio base station 10 may be assumed to have other functional blocks that are necessary for radio communication as well.

The base band signal processing section 104 at least has a control section (scheduler) 301, a transmission signal generation section 302, a mapping section 303, a received signal processing section 304 and a measurement section 305. Note that these configurations have only to be included in the radio base station 10, and some or all of these configurations may not be included in the base band signal processing section 104.

The control section (scheduler) 301 controls the whole of the radio base station 10. The control section 301 can be constituted by a controller, a control circuit or control apparatus that can be described based on general understanding of the technical field to which the present disclosure pertains.

For example, the control section 301 controls the generation of signals in the transmission signal generation section 302, the allocation of signals in the mapping section 303, and the like. Furthermore, the control section 301 controls the signal receiving processes in the received signal processing section 304, the measurements of signals in the measurement section 305, and so on.

The control section 301 controls the scheduling (for example, resource allocation) of system information, downlink data signals (for example, signals transmitted in the PDSCH), and downlink control signals (for example, signals transmitted in the PDCCH and/or the EPDCCH, such as delivery acknowledgment information). The control section 301 controls the generation of downlink control signals, downlink data signals and so on, based on the results of deciding whether or not retransmission control is necessary for uplink data signals, and so on.

Also, the control section 301 controls the scheduling of synchronization signals (for example, the Primary Synchronization Signal (PSS)/Secondary Synchronization Signal (SSS)), SSB, downlink reference signals (for example, the CRS, the CSI-RS, the DMRS, etc.) and so on.

The control section 301 controls the scheduling for uplink data signals (for example, signals transmitted in the PUSCH), uplink control signals (for example, signals that are transmitted in the PUCCH and/or the PUSCH, such as delivery acknowledgment information), random access preambles (for example, signals transmitted in the PRACH), uplink reference signals, and so on.

The control section 301 may perform control to form a transmission beam and/or a reception beam using a digital BF (for example, precoding) in the base band signal processing section 104 and/or an analog BF (for example, phase rotation) in the transmitting/receiving section 103. The control section 301 may perform control to form the beams based on downlink propagation path information, uplink propagation path information, and the like. These pieces of propagation path information may be acquired from the received signal processing section 304 and/or the measurement section 305.

The transmission signal generation section 302 generates downlink signals (downlink control signals, downlink data signals, downlink reference signals and so on) based on instructions from the control section 301, and outputs these signals to the mapping section 303. The transmission signal generation section 302 can be constituted by a signal generator, a signal generating circuit or signal generation apparatus that can be described based on general understanding of the technical field to which the present disclosure pertains.

For example, the transmission signal generation section 302 generates DL assignments, which report downlink data allocation information, and/or UL grants, which report uplink data allocation information, based on instructions from the control section 301. DL assignments and UL grants are both DCI, and follow the DCI format. Also, the downlink data signals are subjected to the coding process, the modulation process and so on, by using coding rates and modulation schemes that are determined based on, for example, channel state information (CSI) reported from each user terminal 20.

The mapping section 303 maps the downlink signals generated in the transmission signal generation section 302 to given radio resources based on commands from the control section 301, and outputs these to the transmitting/receiving sections 103. The mapping section 303 can be constituted by a mapper, a mapping circuit or mapping apparatus that can be described based on general understanding of the technical field to which the present disclosure pertains.

The received signal processing section 304 performs receiving processes (for example, demapping, demodulation, decoding and so on) of received signals that are input from the transmitting/receiving sections 103. Here, the received signals include, for example, uplink signals (uplink control signals, uplink data signals, uplink reference signals, etc.) that are transmitted from the user terminals 20. The received signal processing section 304 can be constituted by a signal processor, a signal processing circuit or signal processing apparatus that can be described based on general understanding of the technical field to which the present disclosure pertains.

The received signal processing section 304 outputs, to the control section 301, information decoded by the receiving processing. For example, when a PUCCH to contain an HARQ-ACK is received, processing section 304 outputs this HARQ-ACK to the control section 301. Also, the received signal processing section 304 outputs the received signals, the signals after the receiving processes and so on, to the measurement section 305.

The measurement section 305 conducts measurements with respect to the received signals. The measurement section 305 can be constituted by a measurer, a measurement circuit or measurement apparatus that can be described based on general understanding of the technical field to which the present disclosure pertains.

For example, the measurement section 305 may perform radio resource management (RRM) measurement, channel state information (CSI) measurement, and the like based on the received signals. The measurement section 305 may measure the received power (for example, reference signal received power (RSRP)), the received quality (for example, reference signal received quality (RSRQ)), the signal to interference plus noise ratio (SINR), the signal to noise ratio (SNR), the signal strength (for example, received signal strength indicator (RSSI)), the propagation path information (for example, CSI), and so on. The measurement results may be output to the control section 301.

The transmitting/receiving section 103 may transmit downlink control information (DCI) (such as DL assignment) for the schedule of the downlink shared channel (for example, PDSCH).

In addition, in the case of repetitive transmission of the downlink shared channel, the transmitting/receiving section 103 may transmit the downlink shared channel at least some of the repetitions. The transmitting/receiving section 103 may transmit the DCI to be used for scheduling all repetitions of the downlink shared channel. The transmitting/receiving section 103 may transmit the DCI to be used for scheduling each given number of repetitions of the downlink shared channel.

The transmitting/receiving section 103 may receive the delivery acknowledgment information at each repetition of the downlink shared channel using the uplink control channel, or may receive the delivery acknowledgment information generated based on all the repetitions of the downlink shared channel.

The control section 301 may control repetitive transmission of the downlink shared channel. Specifically, the control section 301 may control the PDSCH transmission from a different transmission and reception point at each given number of repetitions.

The control section 301 may control at least one of generation and transmission of the DCI to be used for scheduling all repetitions of the downlink shared channel. The control section 301 may control at least one of generation and transmission of the DCI to be used for scheduling each number of repetitions of the downlink shared channel.

The control section 301 may control of reception of the delivery acknowledgment information at each repetition of the downlink shared channel using the uplink control channel, or may control of reception of the delivery acknowledgment information generated based on all the repetitions of the downlink shared channel.

<User Terminal>

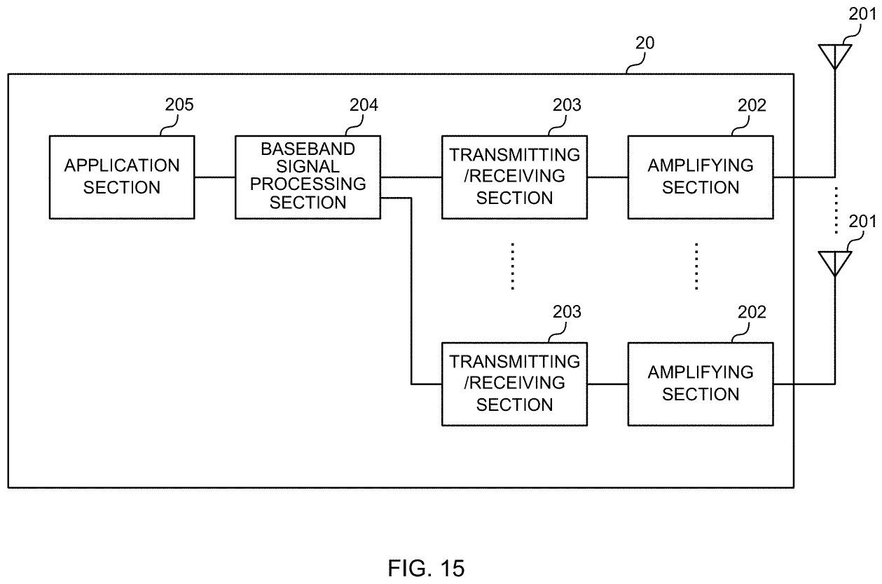

FIG. 15 is a diagram illustrating an example of an overall configuration of a user terminal according to the present embodiment. A user terminal 20 has a plurality of transmitting/receiving antennas 201, amplifying sections 202, transmitting/receiving sections 203, a base band signal processing section 204 and an application section 205. The user terminal 20 may include one or more transmitting/receiving antennas 201, amplifying sections 202 and transmitting/receiving sections 203.

Radio frequency signals that are received in the transmitting/receiving antennas 201 are amplified in the amplifying sections 202. The transmitting/receiving section 203 receives the downlink signal amplified in the amplifying sections 202. The transmitting/receiving section 203 performs frequency conversion for the received signal into base band signal, and outputs the base band signal to the base band signal processing section 204. The transmitting/receiving section 203 can be constituted by a transmitter/receiver, a transmitting/receiving circuit or transmitting/receiving apparatus that can be described based on general understanding of the technical field to which the present disclosure pertains. Note that a transmitting/receiving section 203 may be structured as a transmitting/receiving section in one entity, or may be constituted by a transmitting section and a receiving section.

The base band signal processing section 204 performs receiving processes for the base band signal that is input, including an FFT process, error correction decoding, a retransmission control receiving process and so on. Downlink user data is forwarded to the application section 205. The application section 205 performs processes related to higher layers above the physical layer and the MAC layer and so on. Further, in the downlink data, broadcast information may also be transferred to the application section 205.

Meanwhile, the uplink user data is input from the application section 205 to the base band signal processing section 204. The base band signal processing section 204 performs a retransmission control transmission process (for example, an HARQ transmission process), channel coding, precoding, a discrete Fourier transform (DFT) process, an IFFT process and so on, and the result is forwarded to the transmitting/receiving section 203.

The transmitting/receiving section 203 converts the base band signal that is output from the base band signal processing section 204 into a radio frequency band and transmits it. The radio frequency signals having been subjected to frequency conversion in the transmitting/receiving sections 203 are amplified in the amplifying sections 202, and transmitted from the transmitting/receiving antennas 201.

The transmitting/receiving section 203 may further include an analog beam forming unit that implements analog beamforming. The analog beam forming section may be composed of an analog beam forming circuit (for example, a phase shifter, a phase shift circuit) or an analog beam forming device (for example, a phase shifter), which is described based on common understanding in the technical field according to the present invention. Further, the transmitting/receiving antennas 201 may be composed of an array antenna, for example.

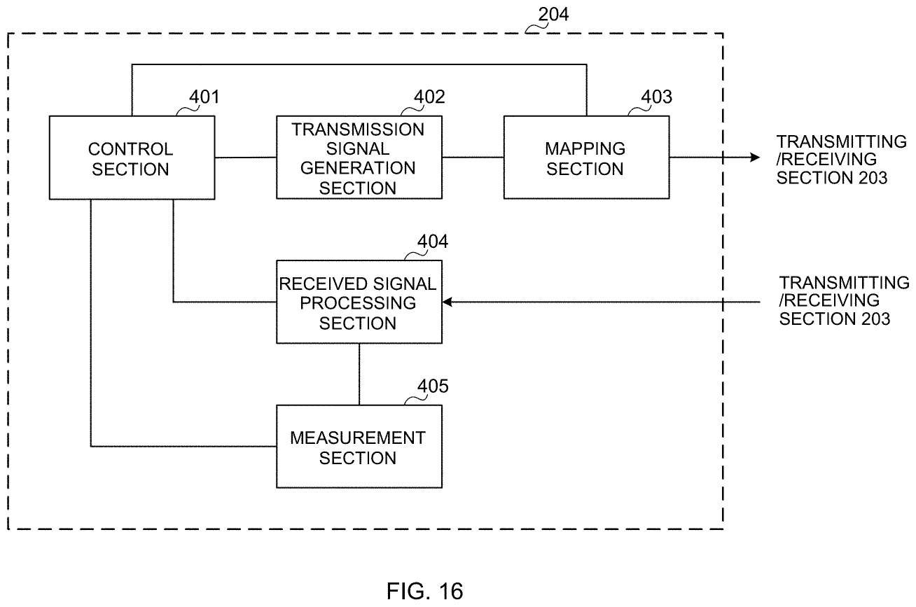

FIG. 16 is a diagram illustrating an example of a functional configuration of the user terminal according to the present embodiment. Note that, although this example will primarily show functional blocks that pertain to characteristic parts of the present embodiment, it may be assumed that the user terminals 20 have other functional blocks that are necessary for radio communication as well.

The base band signal processing section 204 provided in the user terminal 20 at least has a control section 401, a transmission signal generation section 402, a mapping section 403, a received signal processing section 404 and a measurement section 405. These configurations just need to be included in the user terminal 20, and some or all of the configurations need not be included in the base band signal processing section 204.

The control section 401 controls the whole of the user terminal 20. The control section 401 can be constituted by a controller, a control circuit or control apparatus that can be described based on general understanding of the technical field to which the present disclosure pertains.

The control section 401, for example, controls the generation of signals in the transmission signal generation section 402, the allocation of signals in the mapping section 403, and so on. Furthermore, the control section 401 controls the signal receiving processes in the received signal processing section 404, the measurements of signals in the measurement section 405 and so on.

The control section 401 acquires the downlink control signals and downlink data signals transmitted from the radio base station 10, via the received signal processing section 404. The control section 401 controls the generation of uplink control signals and/or uplink data signals based on the results of deciding whether or not retransmission control is necessary for the downlink control signals and/or downlink data signals, and so on.

The control section 401 may perform control to form a transmission beam and/or a reception beam using a digital BF (for example, precoding) in the base band signal processing section 204 and/or an analog BF (for example, phase rotation) in the transmitting/receiving section 203. The control section 401 may perform control to form the beams based on downlink propagation path information, uplink propagation path information and so on. These pieces of propagation path information may be acquired from the received signal processing section 404 and/or the measurement section 405.

Further, when the control section 401 acquires various information reported from the radio base station 10 from the received signal processing section 404, the control section 401 may update the parameter used for control based on the information.

The transmission signal generation section 402 generates uplink signals (uplink control signals, uplink data signals, uplink reference signals, etc.) based on commands from the control section 401, and outputs these signals to the mapping section 403. The transmission signal generation section 402 can be constituted by a signal generator, a signal generating circuit or signal generation apparatus that can be described based on general understanding of the technical field to which the present disclosure pertains.

For example, the transmission signal generation section 402 generates uplink control signals such as delivery acknowledgment information, channel state information (CSI) and so on, based on commands from the control section 401. Also, the transmission signal generation section 402 generates uplink data signals based on commands from the control section 401. For example, when a UL grant is included in a downlink control signal that is reported from the radio base station 10, the control section 401 commands the transmission signal generation section 402 to generate an uplink data signal.

The mapping section 403 maps the uplink signals generated in the transmission signal generation section 402 to radio resources based on commands from the control section 401, and output the result to the transmitting/receiving section 203. The mapping section 403 can be constituted by a mapper, a mapping circuit or mapping apparatus that can be described based on general understanding of the technical field to which the present disclosure pertains.

The received signal processing section 404 performs receiving processes (for example, demapping, demodulation, decoding and so on) of received signals that are input from the transmitting/receiving sections 203. Here, the received signals include, for example, downlink signals (downlink control signals, downlink data signals, downlink reference signals, and so on) that are transmitted from the radio base station 10. The received signal processing section 404 can be constituted by a signal processor, a signal processing circuit or signal processing apparatus that can be described based on general understanding of the technical field to which the present disclosure pertains. Also, the received signal processing section 404 can constitute the receiving section according to the present disclosure.

The received signal processing section 404 outputs the decoded information that is acquired through the receiving processes to the control section 401. The received signal processing section 404 outputs, for example, broadcast information, system information, RRC signaling, DCI, and so on, to the control section 401. Also, the received signal processing section 404 outputs the received signals and/or the signals after the receiving processes to the measurement section 405.

The measurement section 405 conducts measurements with respect to the received signals. For example, the measurement section 405 may perform same frequency measurement and/or different frequency measurement for one or both of the first carrier and the second carrier. When the serving cell is included in the first carrier, the measurement section 405 may perform the different frequency measurement in the second carrier based on a measurement instruction acquired from the received signal processing section 404. The measurement section 405 can be constituted by a measurer, a measurement circuit or measurement apparatus that can be described based on general understanding of the technical field to which the present disclosure pertains.

For example, the measurement section 405 may perform RRM measurements, CSI measurements and so on based on the received signals. The measurement section 405 may measure the received power (for example, RSRP), the received quality (for example, RSRQ, SINR, SNR, etc.), the signal strength (for example, RSSI), propagation path information (for example, CSI), and so on. The measurement results may be output to the control section 401.

The transmitting/receiving sections 203 may receive downlink control information (DCI) (such as DL assignment) for the schedule of the downlink shared channel (for example, PDSCH).

In addition, in the case of repetitive transmission of the downlink shared channel, the transmitting/receiving sections 203 may receive the downlink shared channel from a different transmission and reception point at each number of repetitions. The transmitting/receiving sections 203 may receive the DCI to be used for scheduling all repetitions of the downlink shared channel. The transmitting/receiving sections 203 may receive the DCI to be used for scheduling each given number of repetitions of the downlink shared channel.

The transmitting/receiving sections 203 may transmit the delivery acknowledgment information at each repetition of the downlink shared channel using the uplink control channel, or may transmit the delivery acknowledgment information generated based on all the repetitions of the downlink shared channel, to at least one of the plurality of transmission and reception points.

The control section 401 may control reception of the DCI to be used for scheduling all repetitions of the downlink shared channel. The control section 401 may control reception of the DCI to be used for scheduling each number of repetitions of the downlink shared channel.

The control section 401 may control transmission of the delivery acknowledgment information at each repetition of the downlink shared channel using the uplink control channel, or transmission of the delivery acknowledgment information generated based on all the repetitions of the downlink shared channel, to at least one of the plurality of transmission and reception points.

The control section 401 may determine the spatial relation information for each repetition based on at least one of higher layer signaling and a given field value in the downlink control information used for scheduling of the downlink shared channel, and control the transmission of the delivery acknowledgment information for each repetition based on the spatial relation information.

The control section 401 may determine the resource for the uplink control channel to be equally assigned among all the repetitions, based on at least one of a given field value in the downlink control information and an index of a control channel element (CCE) in which the downlink control information is arranged (the first HARQ-ACK feedback).

The control section 401 may determine the resource for the uplink control channel to be assigned at each repetition, based on at least one of the given field value in the downlink control information and the index of the control channel element (CCE) in which the downlink control information is arranged (the second HARQ-ACK feedback).

The downlink control information may be used for scheduling all the repetitions of the downlink shared channel, or may be used for scheduling of each repetition of the downlink shared channel.

The control section 401 may control the transmission of the delivery acknowledgment information after a lapse of a given period since the reception of each repetition or the last repetition of the downlink shared channel.

<Hardware Configuration>

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be achieved by a single apparatus physically or logically aggregated, or may be achieved by directly or indirectly connecting two or more physically or logically separate apparatuses (using wires, radio, or the like, for example) and using these plural apparatuses.

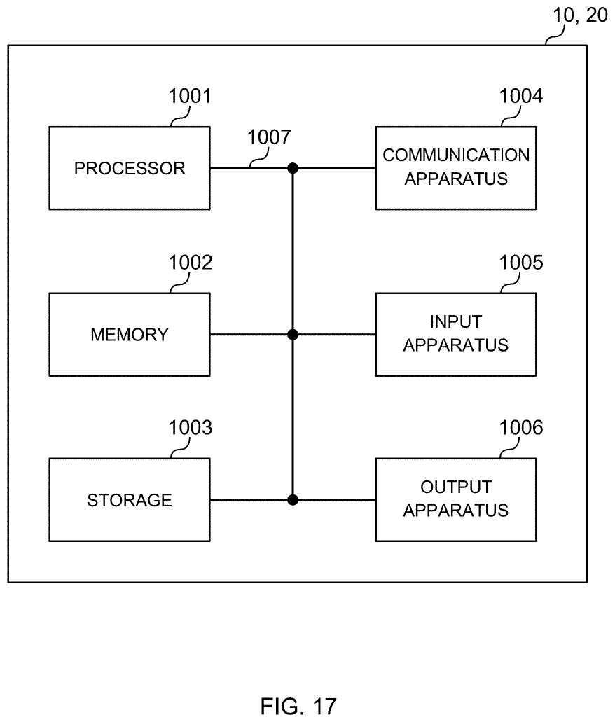

For example, the radio base station, user terminals, and so on according to embodiments of the present disclosure may function as a computer that executes the processes of the radio communication method of the present disclosure. FIG. 17 is a diagram showing an example of a hardware structure of the radio base station and the user terminal according to the embodiment. Physically, the above-described radio base stations 10 and user terminals 20 may be formed as a computer apparatus that includes a processor 1001, a memory 1002, a storage 1003, communication apparatus 1004, input apparatus 1005, output apparatus 1006 and a bus 1007.

In the following description, the word “apparatus” may be interpreted as “circuit”, “device”, “unit”, or the like. The hardware configuration of each of the radio base station 10 and the user terminal 20 may be composed so as to include one or plurality of each apparatus illustrated in the drawing, or may be composed so as not to include a part of the apparatuses.

For example, although only one processor 1001 is shown, a plurality of processors may be provided. Furthermore, processes may be implemented with one processor, or processes may be implemented in sequence, or in different manners, on two or more processors. The processor 1001 may be implemented with one or more chips.

Each function of the radio base station 10 and the user terminal 20 is implemented by reading given software (program) on hardware such as the processor 1001 and the memory 1002, and by controlling the calculations in the processor 1001, the communication in the communication apparatus 1004, and at least one of the reading and writing of data in the memory 1002 and the storage 1003.

The processor 1001 controls the whole computer by, for example, running an operating system. The processor 1001 may be configured with a central processing unit (CPU), which includes interfaces with peripheral equipment, control apparatus, computing apparatus, a register and so on. For example, the base band signal processing section 104 (204), the call processing section 105 and the like, which are mentioned above, may be achieved by the processor 1001.

Furthermore, the processor 1001 reads programs (program codes), software modules, or data, from at least one of the storage 1003 and the communication apparatus 1004, into the memory 1002, and executes various processes according to these. As for the programs, programs to allow computers to execute at least part of the operations described in the above-described embodiments may be used. For example, the control section 401 of the user terminals 20 may be implemented by control programs that are stored in the memory 1002 and that operate on the processor 1001, and other functional blocks may be implemented likewise.

The memory 1002 is a computer-readable recording medium, and may be composed of, for example, at least one of a read only memory (ROM), an erasable programmable ROM (EPROM), an electrically EPROM (EEPROM), a random access memory (RAM), and other appropriate storage media. The memory 1002 may be referred to as a “register,” a “cache,” a “main memory (main storage device)” and so on. The memory 1002 can store a program (program code), a software module, and the like, which are executable for implementing the radio communication method according to the embodiment of the present disclosure.

The storage 1003 is a computer-readable recording medium, and for example, may be composed of at least one of a flexible disk, a floppy (registered trademark) disk, a magneto-optical disk (for example, a compact disc (compact disc ROM (CD-ROM) and the like), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus”.

The communication apparatus 1004 is hardware (transmitting/receiving device) for performing inter-computer communication via at least one of a wired network and a wireless network, and for example, is referred to as “network device”, “network controller”, “network card”, “communication module”, and the like. The communication apparatus 1004 may be configured to include a high frequency switch, a duplexer, a filter, a frequency synthesizer and so on in order to implement, for example, at least one of frequency division duplex (FDD) and time division duplex (TDD). For example, the above-described transmitting/receiving antennas 101 (201), amplifying sections 102 (202), transmitting/receiving sections 103 (203), communication path interface 106 and so on may be implemented by the communication apparatus 1004.

The input apparatus 1005 is an input device for receiving input from the outside (for example, a keyboard, a mouse, a microphone, a switch, a button, a sensor and so on). The output apparatus 1006 is an output device for allowing output to the outside (for example, a display, a speaker, a light emitting diode (LED) lamp, and so on). Note that the input apparatus 1005 and the output apparatus 1006 may be provided in an integrated structure (for example, a touch panel).

Furthermore, these pieces of apparatus, including the processor 1001, the memory 1002 and so on are connected by the bus 1007 so as to communicate information. The bus 1007 may be formed with a single bus, or may be formed with buses that vary between pieces of apparatus.

Also, the radio base station 10 and the user terminal 20 may be configured to include hardware such as a microprocessor, a digital signal processor (DSP), an application-specific integrated circuit (ASIC), a programmable logic device (PLD), and a field programmable gate array (FPGA), and all or some of the functional blocks may be implemented by the hardware. For example, the processor 1001 may be implemented with at least one of these pieces of hardware.

(Modifications)

Note that the terminology described in the present disclosure and the terminology that is needed to understand the present disclosure may be replaced with other terms that convey the same or similar meanings. For example, at least one of “channels” and “symbols” may be replaced by “signals” (or “signaling”). The signal may also be a message. A reference signal may be abbreviated as an RS, and may be referred to as a pilot, a pilot signal, and so on, depending on which standard applies. Furthermore, a “component carrier (CC)” may be referred to as a “cell,” a “frequency carrier,” a “carrier frequency” and so on.

A radio frame may be comprised of one or more periods (frames) in the time domain. Each of one or a plurality of periods (frames) constituting a radio frame may be referred to as a subframe. Furthermore, a subframe may be comprised of one or a plurality of slots in the time domain. A subframe may be a fixed time duration (for example, 1 ms) that is not dependent on numerology.

Here, the numerology may be a communication parameter used for at least one of transmission and reception of a certain signal or channel. For example, the numerology may indicate at least one of SubCarrier Spacing (SCS), a bandwidth, a symbol length, a cyclic prefix length, a transmission time interval (TTI), the number of symbols per TTI, a radio frame structure, a specific filtering process to be performed by a transceiver in the frequency domain, a specific windowing process to be performed by a transceiver in the time domain and so on.

A slot may be comprised of one or a plurality of symbols in the time domain (orthogonal frequency division multiplexing (OFDM) symbols, single carrier frequency division multiple access (SC-FDMA) symbols, and so on). Also, a slot may be a time section based on numerology.

A slot may include a plurality of mini slots. Each mini slot may be comprised of one or more symbols in the time domain. Also, a mini slot may be referred to as a “subslot.” Each mini slot may be comprised of fewer symbols than a slot. A PDSCH (or PUSCH) transmitted in a time section larger than a mini slot may be referred to as PDSCH (PUSCH) mapping type A. A PDSCH (or PUSCH) transmitted using a mini slot may be referred to as PDSCH (PUSCH) mapping type B.

A radio frame, a subframe, a slot, a mini slot and a symbol all represent the time section in signal communication. A radio frame, a subframe, a slot, a mini slot and a symbol may be each called by other applicable names. Time units such as frame, subframe, slot, mini slot, and symbol in the present disclosure may be replaced with each other.

For example, one subframe may be referred to as a “transmission time interval (TTI),” or a plurality of consecutive subframes may be referred to as a “TTI,” or one slot or one mini slot may be referred to as a “TTI”. That is, at least one of a subframe and a TTI may be a subframe (1 ms) in the existing LTE, may be a shorter period than 1 ms (for example, one to thirteen symbols), or may be a longer period of time than 1 ms. The unit to represent the TTI may be referred to as “slot”, “mini slot”, or the like, instead of “subframe”.

Here, the TTI means the minimum time unit of scheduling in radio communication, for example. For example, in LTE systems, a radio base station schedules the radio resources (such as the frequency bandwidth and transmission power that can be used in each user terminal) to allocate to each user terminal in TTI units. The definition of TTIs is not limited thereto.

The TTI may be the transmission time section of channel-encoded data packets (transport blocks), code blocks, codewords and so on, or may be the section of processing in scheduling, link adaptation and so on. When TTI is given, a time interval (for example, the number of symbols) in which the transport blocks, the code blocks, the codewords, and the like are actually mapped may be shorter than TTI.

Note that, when one slot or one mini slot is referred to as a “TTI,” one or more TTIs (that is, one or multiple slots or one or more mini slots) may be the minimum time section of scheduling. Also, the number of slots (the number of mini slots) to constitute this minimum time section of scheduling may be controlled.

TTI having a time length of 1 ms may be called usual TTI (TTI in LTE Rel. 8 to 12), normal TTI, long TTI, a usual subframe, a normal subframe, a long subframe, a slot, or the like. A TTI that is shorter than a usual TTI may be referred to as “shortened TTI”, “short TTI”, “partial TTI” (or “fractional TTI”), “shortened subframe”, “short subframe”, “mini slot”, “sub-slot”, “slot”, or the like.

The long TTI (for example, the usual TTI, the subframe, and the like) may be replaced by TTI having a time length exceeding 1 ms, and the short TTI (for example, the shortened TTI and the like) may be replaced by TTI having a TTI length less than the TTI length of the long TTI and not less than 1 ms.

The resource block (RB) is the unit of resource allocation in the time domain and the frequency domain, and may include one or plurality of consecutive subcarriers in the frequency domain. The number of subcarriers included in the RB may be the same regardless of the numerology, and may be 12, for example. The number of subcarriers included in the RB may be determined based on the numerology.

Also, the RB may include one or more symbols in the time domain, and may be one slot, one mini slot, one subframe, or one TTI in length. One TTI, one subframe, and the like each may be comprised of one or more resource blocks.

One or a plurality of RBs may be referred to as “physical resource block (physical RB (PRB))”, “subcarrier group (SCG)”, “resource element group (REG)”, “PRB pair”, “RB pair”, or the like.

Furthermore, the resource block may be comprised of one or more resource elements (REs). For example, one RE may be a radio resource domain of one subcarrier and one symbol.

The bandwidth part (BWP) (also called partial bandwidth etc.) may refer to a subset of consecutive common resource blocks (RBs) for certain numerology in a certain carrier. Here, the common RB may be specified by the index of the RB with reference to the common reference point of the carrier. The PRBs may be defined in a BWP and numbered within the BWP.

The BWP may include a BWP for UL (UL BWP) and a BWP for DL (DL BWP). For the UE, one or more BWPs may be configured within one carrier.

At least one of the configured BWPs may be active, and the UE do not need to take account of transmitting or receiving a given signal/channel outside the active BWP. The terms “cell”, “carrier”, and the like in the present disclosure may be replaced with “BWP”.

Note that the structures of radio frames, subframes, slots, mini slots, symbols and so on described above are merely examples. For example, configurations pertaining to the number of subframes included in a radio frame, the number of slots included in a subframe, the number of mini-slots included in a slot, the number of symbols and RBs included in a slot or a mini slot, the number of subcarriers included in an RB, the number of symbols in a TTI, the symbol duration, the length of cyclic prefixes (CPs) and so on can be variously changed.

Also, the information and parameters described in the present disclosure may be represented in absolute values or in relative values with respect to given values, or may be represented using other applicable information. For example, a radio resource may be specified by a given index.

The names used for parameters and so on in the present disclosure are in no respect limiting. In addition, an equation and so on using these parameters may differ from those explicitly disclosed in the present disclosure. Since various channels (physical uplink control channel (PUCCH), physical downlink control channel (PDCCH), and the like) and information elements can be identified by any suitable names, the various names assigned to these individual channels and information elements are in no respect limiting.

The information, signals and/or others described in the present disclosure may be represented by using a variety of different technologies. For example, data, instructions, commands, information, signals, bits, symbols and chips, all of which may be referenced throughout the herein-contained description, may be represented by voltages, currents, electromagnetic waves, magnetic fields or particles, optical fields or photons, or any combination of these.

Further, information, signals and the like can be output in at least one of a direction from higher layers to lower layers and a direction from lower layers to higher layers. Information, signals and so on may be input and output via a plurality of network nodes.

The information, signals and so on that are input and/or output may be stored in a specific location (for example, in a memory), or may be managed in a control table. The information, signals, and so on that are input and/or output can be overwritten, updated, or appended. The information, signals, and so on that are output may be deleted. The information, signals and so on that are input may be transmitted to other pieces of apparatus.

The reporting of information is by no means limited to the aspects/embodiments described in the present disclosure, and may be performed using other methods. For example, the reporting of information may be implemented by physical layer signaling (for example, downlink control information (DCI), uplink control information (UCI)), higher layer signaling (for example, radio resource control (RRC) signaling, broadcast information (master information block (MIB), system information block (SIB), and the like), and medium access control (MAC) signaling), other signals, or combinations of these.

Physical layer signaling may be referred to as “Layer 1/Layer 2 (L1/L2) control information (L1/L2 control signals)”, “L1 control information (L1 control signal)”, or the like. Also, RRC signaling may be referred to as RRC messages, and can be, for example, an RRC connection setup message, RRC connection reconfiguration message, and so on. Also, MAC signaling may be reported using, for example, MAC control elements (MAC CEs).

Also, reporting of given information (for example, reporting of information to the effect that “X holds”) does not necessarily have to be sent explicitly, and can be sent implicitly (for example, by not reporting this piece of information, by reporting another piece of information, and so on).

Decisions may be made in values represented by one bit (0 or 1), may be made in Boolean values that represent true or false, or may be made by comparing numerical values (for example, comparison against a given value).

Software, whether referred to as “software,” “firmware,” “middleware,” “microcode” or “hardware description language,” or called by other names, should be interpreted broadly, to mean instructions, instruction sets, code, code segments, program codes, programs, subprograms, software modules, applications, software applications, software packages, routines, subroutines, objects, executable files, execution threads, procedures, functions and so on.

Also, software, commands, information and so on may be transmitted and received via communication media. For example, when software is transmitted from a website, a server or other remote sources by using at least one of wired technologies (coaxial cables, optical fiber cables, twisted-pair cables, digital subscriber lines (DSLs), and the like) and wireless technologies (infrared radiation, microwaves, and the like), at least one of these wired technologies and wireless technologies are also included in the definition of communication media.

The terms “system” and “network” as used in the present disclosure are used interchangeably.

In the present disclosure, the terms such as “precoding”, “precoder”, “weight (precoding weight)”, “transmission power”, “phase rotation”, “antenna port”, “layer”, “layer number”, “rank”, “beam”, “beam width”, “beam angle”, “antenna”, “antenna element”, “panel” and the like may be used interchangeably.

In the present disclosure, the terms such as “base station (BS)”, “radio base station”, “fixed station”, “NodeB”, “eNodeB (eNB)”, “gNodeB (gNB)”, “access point”, “transmission point (TP)”, “reception point (RP)”, “transmission/reception point”, “cell”, “sector”, “cell group”, “carrier”, “component carrier”, and the like may be used interchangeably. The base station may be called a term such as a macro cell, a small cell, a femto cell, a pico cell, and the like.

The base station can accommodate one or a plurality of (for example, three) cells. When the base station accommodates a plurality of cells, the entire coverage area of the base station can be partitioned into a plurality of smaller areas, and each smaller area can provide the communication service through the base station subsystem (for example, indoor small base station (remote radio head (RRH)). The term “cell” or “sector” refers to all or part of the coverage area of at least one of a base station and a base station subsystem that provides communication services within this coverage.

In the present disclosure, the terms such as “mobile station (MS)”, “user terminal”, “user terminal (UE)”, “terminal”, etc. may be used interchangeably.

The mobile station may be referred to as a subscriber station, mobile unit, subscriber unit, wireless unit, remote unit, mobile device, wireless device, wireless communication device, remote device, mobile subscriber station, access terminal, mobile terminal, wireless terminal, remote terminal, handset, user agent, mobile client, client, or some other suitable terms.

At least one of a base station and a mobile station may be referred to as transmitting apparatus, receiving apparatus and so on. Note that at least one of the base station and the mobile station may be a device mounted on a mobile unit, a mobile section itself, or the like. The mobile section may be a vehicle (such as a car, an airplane, for example), an unmanned mobile section (such as a drone, an autonomous vehicle, for example), or a robot (manned or unmanned). Note that at least one of the base station and the mobile station also includes a device that does not necessarily move during a communication operation.

Furthermore, the radio base stations in the present disclosure may be interpreted as user terminals. For example, each aspect/embodiment of the present disclosure may be applied to a configuration in which communication between a radio base station and a user terminal is replaced by communication among a plurality of user terminals (which may be referred to as, for example, D2D (Device-to-Device), V2X (Vehicle-to-Everything) and so on). In this case, the user terminal 20 may have the functions of the radio base station 10 described above. The wording such as “up” and “down” may be replaced with the wording corresponding to the terminal-to-terminal communication (for example, “side”). For example, the uplink channel and the downlink channel may be interpreted as a side channel.

Likewise, the user terminals in the present disclosure may be interpreted as radio base stations. In this case, the radio base stations 10 may have the functions of the user terminals 20 described above.

Certain actions that have been described in the present disclosure to be performed by base stations may, in some cases, be performed by their upper nodes. In a network including one or a plurality of network nodes with base stations, it is clear that various operations that are performed so as to communicate with terminals can be performed by base stations, one or more network nodes (for example, mobility management entities (MMEs), serving-gateways (S-GWs), and the like may be possible, but these are not limiting) other than base stations, or combinations of these.

The aspects/embodiments illustrated in the present disclosure may be used individually or in combinations, which may be switched depending on the aspect of implementation. The order of processes, sequences, flowcharts and so on that have been used to describe the aspects/embodiments in the present disclosure may be re-ordered as long as inconsistencies do not arise. For example, although various methods have been illustrated in the present disclosure with various components of steps using exemplary orders, the specific orders that are illustrated herein are by no means limiting.

The aspects/embodiments illustrated in the present disclosure may be applied to long term evolution (LTE), LTE-advanced (LTE-A), LTE-beyond (LTE-B), SUPER 3G, IMT-Advanced, 4th generation mobile communication system (4G), 5th generation mobile communication system (5G), future radio access (FRA), New-radio access technology (RAT), new radio (NR), new radio access (NX), future generation radio access (FX), global system for mobile communications (GSM) (registered trademark), CDMA 2000, ultra mobile broadband (UMB), IEEE 802.11 (Wi-Fi (registered trademark)), IEEE 802.16 (WiMAX (registered trademark)), IEEE 802.20, ultra-wideband (UWB), Bluetooth (registered trademark), systems that use other adequate radio communication methods and/or next generation systems that are enhanced based on these. Further, a plurality of systems may be combined and applied (for example, a combination of LTE or LTE-A and 5G).

The phrase “based on” as used in the present disclosure does not mean “based only on”, unless otherwise specified. In other words, the phrase “based on” means both “based only on” and “based at least on”.

Reference to elements with designations such as “first,” “second” and so on as used in the present disclosure does not generally limit the number/quantity or order of these elements. These designations are used in the present disclosure only for convenience, as a method for distinguishing between two or more elements. In this way, reference to the first and second elements does not imply that only two elements may be employed, or that the first element must precede the second element in some way.

The terms “judge” and “determine” as used in the present disclosure may encompass a wide variety of actions. For example, “determining” may be regarded as “determining” judging, calculating, computing, processing, deriving, investigating, looking up (for example, looking up in a table, database, or another data structure), ascertaining, and the like.

Furthermore, to “judge” and “determine” as used herein may be interpreted to mean making judgements and determinations related to receiving (for example, receiving information), transmitting (for example, transmitting information), inputting, outputting, accessing (for example, accessing data in a memory) and so on.

In addition, to “judge” and “determine” as used herein may be interpreted to mean making judgements and determinations related to resolving, selecting, choosing, establishing, comparing and so on. In other words, to “judge” and “determine” as used herein may be interpreted to mean making judgements and determinations related to some action.

In addition, to “judge” and “determine” as used herein may be interpreted to mean “assuming”, “expecting”, “considering” and so on.

The term “maximum transmission power” described in the present disclosure may mean the maximum value of transmission power, the nominal UE maximum transmit power, or the rated UE maximum transmit power.

As used in the present disclosure, the terms “connected” and “coupled,” or any variation of these terms, mean all direct or indirect connections or coupling between two or more elements, and may include the presence of one or more intermediate elements between two elements that are “connected” or “coupled” to each other. The coupling or connection between the elements may be physical, logical, or a combination of these. For example, “connection” may be replaced by “access”.

As used in the present disclosure, when two elements are connected, these elements may be considered “connected” or “coupled” to each other by using one or more electrical wires, cables, printed electrical connections, and the like, and, as some non-limiting and non-inclusive examples, by using electromagnetic energy, such as electromagnetic energy having wavelengths in the radio frequency, microwave, and optical (both visible and invisible) domains.

In the present disclosure, the phrase “A and B are different” may mean “A and B are different from each other.” The phrase may mean that “A and B are each different from C”. The terms such as “leave” and “coupled” may be interpreted in a manner similar to the term “different”.

When the terms such as “include,” “including”, and variations of these are used in the present disclosure, these terms are intended to be inclusive, in a manner similar to the way the term “comprising” is used. Furthermore, the term “or” as used in the present disclosure is intended to be not an exclusive-OR.

In the present disclosure, where translations add articles, such as a, an, and the in English, the present disclosure may include that the noun that follows these articles is in the plural.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of the claims. Consequently, the description in the present disclosure is provided only for the purpose of explaining examples, and should by no means be construed to limit the invention according to the present disclosure in any way.

1. A user terminal comprising:
a receiving section that receives a downlink shared channel repetitively transmitted from a plurality of transmission and reception points; and
a control section that controls transmission of delivery acknowledgment information at each repetition of the downlink shared channel or transmission of delivery acknowledgment information generated based on all the repetitions of the downlink shared channel, using an uplink control channel to at least one of the plurality of transmission and reception points.

2. The user terminal according to claim 1, wherein the control section determines spatial relation information for the each repetition based on at least one of higher layer signaling and a given field value in downlink control information used for scheduling of the downlink shared channel, and controls the transmission of the delivery acknowledgment information for the each repetition based on the spatial relation information.

3. The user terminal according to claim 1, wherein the control section determines a resource for the uplink control channel to be equally assigned among all the repetitions, based on at least one of a given field value in the downlink control information and an index of a control channel element (CCE) in which the downlink control information is arranged.

4. The user terminal according to claim 1, wherein the control section determines a resource for the uplink control channel assigned at each repetition, based on at least one of a given field value in the downlink control information and the index of the control channel element (CCE) in which the downlink control information is arranged.

5. The user terminal according to claim 1, wherein the downlink control information is used for scheduling all the repetitions of the downlink shared channel, or is used for scheduling of each repetition of the downlink shared channel.

6. The user terminal according to claim 1, wherein the control section controls the transmission of the delivery acknowledgment information after a lapse of a given period since the reception of each repetition or the last repetition of the downlink shared channel.

7. The user terminal according to claim 2, wherein the control section determines a resource for the uplink control channel to be equally assigned among all the repetitions, based on at least one of a given field value in the downlink control information and an index of a control channel element (CCE) in which the downlink control information is arranged.

8. The user terminal according to claim 2, wherein the control section determines a resource for the uplink control channel assigned at each repetition, based on at least one of a given field value in the downlink control information and the index of the control channel element (CCE) in which the downlink control information is arranged.

9. The user terminal according to claim 2, wherein the downlink control information is used for scheduling all the repetitions of the downlink shared channel, or is used for scheduling of each repetition of the downlink shared channel.

10. The user terminal according to claim 3, wherein the downlink control information is used for scheduling all the repetitions of the downlink shared channel, or is used for scheduling of each repetition of the downlink shared channel.

11. The user terminal according to claim 4, wherein the downlink control information is used for scheduling all the repetitions of the downlink shared channel, or is used for scheduling of each repetition of the downlink shared channel.

12. The user terminal according to claim 2, wherein the control section controls the transmission of the delivery acknowledgment information after a lapse of a given period since the reception of each repetition or the last repetition of the downlink shared channel.

13. The user terminal according to claim 3, wherein the control section controls the transmission of the delivery acknowledgment information after a lapse of a given period since the reception of each repetition or the last repetition of the downlink shared channel.

14. The user terminal according to claim 4, wherein the control section controls the transmission of the delivery acknowledgment information after a lapse of a given period since the reception of each repetition or the last repetition of the downlink shared channel.

15. The user terminal according to claim 5, wherein the control section controls the transmission of the delivery acknowledgment information after a lapse of a given period since the reception of each repetition or the last repetition of the downlink shared channel.
